(19) United States
(12) Patent Application Publication
(10) Pub. No.: US 2008/0152324 A1
(43) Pub. Date: Jun. 26, 2008

(54) OPTICAL DISK APPARATUS AND OPTICAL DISK PROCESSING METHOD

(76) Inventors: Yuki Kaneko, Yokohama-shi (JP); Mieko Onodera, Yokohama-shi (JP); Yoichiro Yamagata, Yokohama-shi (JP); Yasufumi Tsumagari, Kawasaki-shi (JP); Shinichi Kikuchi, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/957,803

(22) Filed: Dec. 17, 2007

(30) Foreign Application Priority Data
Dec. 22, 2006 (JP) 2006-346246

(51) Int. Cl. H04N 3/02

(52) U.S. Cl. 386/126

(57) ABSTRACT

According to one embodiment, there is provided an optical disk apparatus including a scanning unit which scans light reflected from an optical disk to output a scan signal, a management unit which manages which object is currently brought into focus in a plurality of objects on a screen based on the scan signal scanned by the scanning unit and a given operation signal, and a processing unit which generates a signal for informing a user of the object brought into focus.

### CROSS-REFERENCE TO RELATED APPLICATION

This application is based upon and claims the benefit of priority from Japanese Patent Application No. 2006-346246, filed Dec. 22, 2006, the entire contents of which are incorporated herein by reference.

### BACKGROUND

1. Field

One embodiment of the invention relates to an optical disk apparatus, and particularly to an optical disk apparatus and an optical disk processing method for highlighting an object brought into focus in plural objects on a screen in reproducing contents.

2. Description of the Related Art

Currently, a transition from DVD to HD DVD is started, and a more complicated object arrangement and a focus moving rule can be set in an HD DVD standard. Obviously a content creator should try to set the object arrangement and the focus moving rule such that a user is not puzzled. However, there may be sometimes generated such situations that the user cannot recognize which object is brought into focus and the user cannot recognize which object is brought into focus when next performing a downward operation.

For example, in a website on the Internet, even if the object arrangement is complicated, the object can directly be assigned by a mouse cursor, and the user does not feel much inconvenience because the use of the mouse cursor is common. However, in viewing an HD DVD-Video, because it is predicted that the object is usually assigned by an arrow key rather than the object assignment performed by the mouse cursor, the user is significantly inconvenienced even if the complexity on the screen of the HD DVD-Video is similar to that of the website on the Internet. There are known various techniques to complement operability of the optical disk apparatus.

Jpn. Pat. Appln. KOKAI Publication No. 11-238367 discloses a technique in which a disabled key on a remote controller of the optical disk apparatus is ghost-displayed on the screen, thereby eliminating such a trouble that the user operates the disabled key to feel confused without knowing that the key is disabled.

However, the function of causing the user to recognize the object brought into focus on the screen is not shown in the technique disclosed in Jpn. Pat. Appln. KOKAI Publication No. 11-238367. That is, there is a problem in that the user cannot know which object is brought into focus, in the case where the function of highlighting the object currently brought into focus to cause the user to recognize the object is not possessed in content information stored in the optical disk.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory view showing a schematic example of an HD DVD reproducing apparatus according to an embodiment of the invention;

FIG. 2 is an explanatory view showing a schematic example of HD DVD contents according to an embodiment of the invention;

FIG. 3 is a flowchart showing an example of a process for distinguishing between standard contents and advanced contents in an HD DVD reproducing apparatus according to an embodiment of the invention;

FIG. 4 is a flowchart showing an example of a focus guide process in a standby state for user operation in an HD DVD reproducing apparatus according to an embodiment of the invention;

FIG. 5 is a flowchart showing a schematic example of a focus guide process in an HD DVD reproducing apparatus according to an embodiment of the invention;

FIG. 6 is a block diagram showing a configuration example of an HD DVD reproducing apparatus according to an embodiment of the invention;

FIG. 7 is an appearance view showing an example of a remote controller used in an HD DVD reproducing apparatus according to an embodiment of the invention;

FIG. 8 is a block diagram showing a configuration example for performing a focus guide process in an HD DVD reproducing apparatus according to an embodiment of the invention;

FIG. 9 is an explanatory view showing an example of a focus guide process in an HD DVD reproducing apparatus according to an embodiment of the invention;

FIG. 10 is an explanatory view showing another example of a focus guide process in an HD DVD reproducing apparatus according to an embodiment of the invention;

FIG. 11 is an explanatory view showing another example of a focus guide process in an HD DVD reproducing apparatus according to an embodiment of the invention;

FIG. 12 is an explanatory view showing another example of a focus guide process in an HD DVD reproducing apparatus according to an embodiment of the invention;

FIG. 13 is an explanatory view showing another example of a focus guide process in an HD DVD reproducing apparatus according to an embodiment of the invention;

FIG. 14 is an explanatory view showing an example of image superimposing in an HD DVD reproducing apparatus according to an embodiment of the invention;

FIG. 15 is an explanatory view showing an example of an object arrangement in an HD DVD reproducing apparatus according to an embodiment of the invention;

FIG. 16 is an explanatory view showing an example of Markup setting in an HD DVD reproducing apparatus according to an embodiment of the invention;

FIG. 17 is an explanatory view showing an example of navIndex setting in an HD DVD reproducing apparatus according to an embodiment of the invention;

FIG. 18 is an explanatory view showing an example of a focus guide in an HD DVD reproducing apparatus according to an embodiment of the invention;

FIG. 19 is a flowchart showing an example of a focus guide process performed to advanced contents in an HD DVD reproducing apparatus according to an embodiment of the invention;

FIG. 20 is a flowchart showing an example of a focus guide process performed to advanced contents in an HD DVD reproducing apparatus according to an embodiment of the invention;

FIG. 21 is a flowchart showing an example of a focus guide process performed to advanced contents in an HD DVD reproducing apparatus according to an embodiment of the invention;

FIG. 22 is an explanatory view showing an example of a focus guide in an HD DVD reproducing apparatus according to an embodiment of the invention;

FIG. 23 is an explanatory view showing another example of a focus guide in an HD DVD reproducing apparatus according to an embodiment of the invention;

FIG. 24 is an explanatory view showing another example of a focus guide in an HD DVD reproducing apparatus according to an embodiment of the invention;

FIG. 25 is an explanatory view schematically showing a process for reproducing standard contents in an HD DVD reproducing apparatus according to an embodiment of the invention;

FIG. 26 is a flowchart showing an example of a focus guide process performed to standard contents in an HD DVD reproducing apparatus according to an embodiment of the invention;

FIG. 27 is an explanatory view showing an example of a focus guide process performed to standard contents in an HD DVD reproducing apparatus according to an embodiment of the invention;

FIG. 28 is an explanatory view showing an example of a focus guide process performed to standard contents in an HD DVD reproducing apparatus according to an embodiment of the invention;

FIG. 29 is an explanatory view showing an example of a focus guide process performed to standard contents in an HD DVD reproducing apparatus according to an embodiment of the invention;

FIG. 30 is an explanatory view showing an example of a focus guide process performed to standard contents in an HD DVD reproducing apparatus according to an embodiment of the invention;

FIG. 31 is an explanatory view showing an example of a focus guide process performed to standard contents in an HD DVD reproducing apparatus according to an embodiment of the invention; and

FIG. 32 is a flowchart showing an example of a focus guide process performed to standard contents in an HD DVD reproducing apparatus according to an embodiment of the invention.

### DETAILED DESCRIPTION

Various embodiments according to the invention will be described hereinafter with reference to the accompanying drawings. In general, according to one embodiment of the invention, an optical disk apparatus comprising: a scanning unit which scans light reflected from an optical disk to output a scan signal; a management unit which manages which object is currently brought into focus in a plurality of objects on a screen based on the scan signal scanned by the scanning unit and a given operation signal; and a processing unit which generates a signal for informing a user of the object brought into focus.

An embodiment of the invention provides an optical disk apparatus and an optical disk processing method, wherein the object currently brought into focus is highlighted to display prediction of the object to which the focus is transferred by the next operation.

One embodiment for achieving the object is an optical disk apparatus comprising:

a scanning unit (14) which scans light reflected from an optical disk to output a scan signal;

a management unit (11) which manages which object is currently brought into focus in a plurality of objects (A to G) on a screen based on the scan signal scanned by the scanning unit and a given operation signal; and

a processing unit (12-1, 13-1) which generates a signal for informing a user of the object brought into focus.

Accordingly, the user can recognize the object currently brought into focus even if the display function is not included in contents. Additionally, on the screen, the user can recognize the destination object of the focus according to the arrow key of the remote controller.

An embodiment of the invention will be described in detail with reference to the drawings.

<Optical Disk Apparatus According to One Embodiment of the Present Invention>

(Outline of HD DVD)

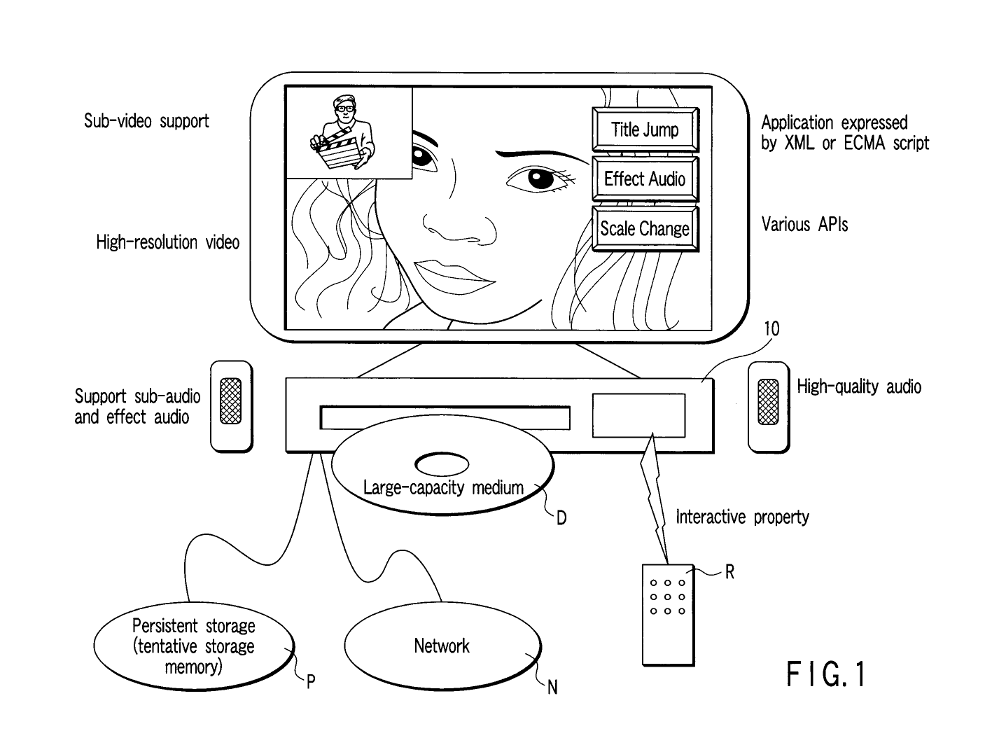

FIG. 1 is an explanatory view showing a schematic example of an HD DVD reproducing apparatus according to an embodiment of the invention. HD DVD is a next-generation standard of DVD, and is characterized by having high-quality video and audio, improved interactive property with a remote controller R, and network support. As shown in FIG. 1, a HD DVD reproducing apparatus 10 is compatible with various video and audio CODECs (compression format) and also has well developed API (function group defined by the standard), so that a content creator can realize attractive and diverse contents. Such advantages rapidly advance the transition from current DVD to HD DVD.

(Standard Contents and Advanced Contents)

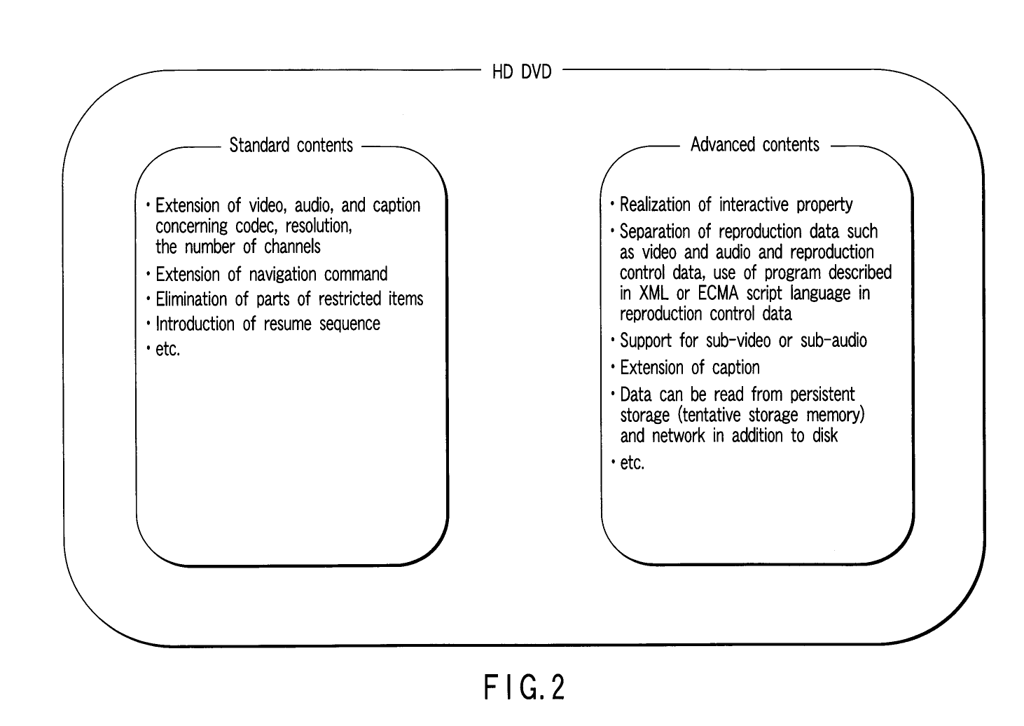

FIG. 2 is an explanatory view showing a schematic example of HD DVD contents according to an embodiment of the invention. As shown in FIG. 2, two types of contents called standard contents and advanced contents are defined in the HD DVD standard.

The standard contents are a position of the extended current DVD standard. A data configuration of the standard contents is close to that of the current DVD standard, and it is believed that a studio which produces the current DVD easily accepts the standard contents. Additionally, the standard contents have features such as the high-quality video and audio and the extended usable navigation command (command group used in title jump and menu).

On the other hand, the advanced contents differ completely from the contents of the current DVD. In the advanced contents, in addition to the high-quality video and audio as in the standard contents, reproduction control information is expressed by a programming language such as XML and ECMA Script like the website on the Internet. Conventionally it is necessary that all pieces of data required to reproduce contents be read from an optical disk D. On the other hand, in the advanced contents of HD DVD, as shown in FIG. 1, in addition to the optical disk D, it is possible that the data is read from a persistent storage (tentative storage memory) P, and that the data is downloaded through a network N and utilized for the reproduction.

Thus, the two types of contents are defined in HD DVD, and the standard contents differ from the advanced contents in the data structure and the like. A focus guide process according to an embodiment of the invention is concerned with the reproduction control information on contents, so that realization of the focus guide process depends on the two types of contents.

(Outline of Focus Guide Process)

Then, a general outline of the focus guide process according to an embodiment of the invention will be described in detail with reference to three flowcharts.

Distinction between Standard Contents and Advanced Contents

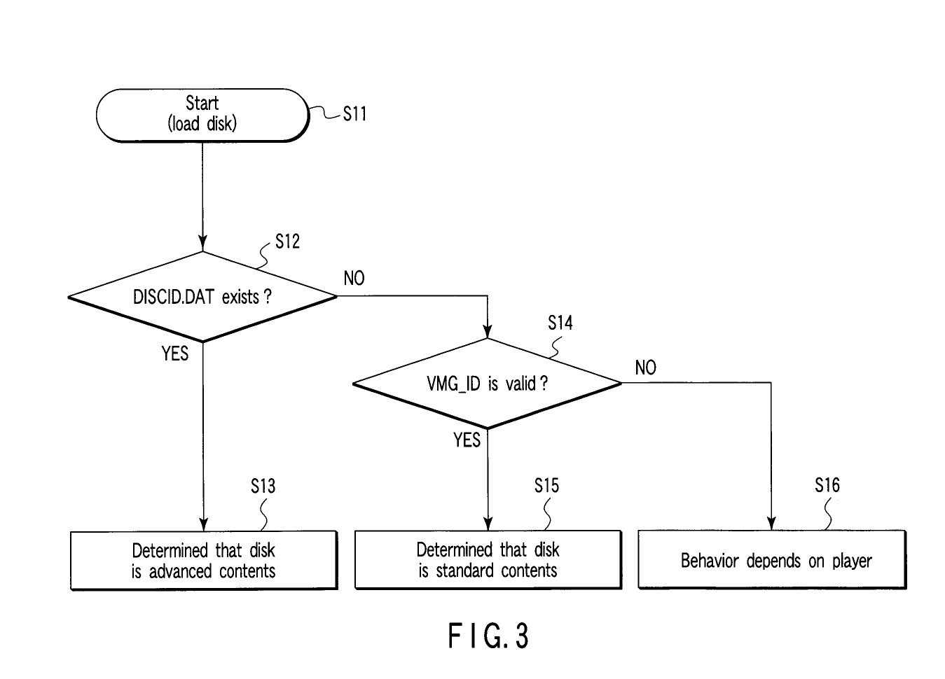

FIG. 3 is a flowchart showing an example of a process for distinguishing between standard contents and advanced contents in the HD DVD reproducing apparatus according to an embodiment of the invention.

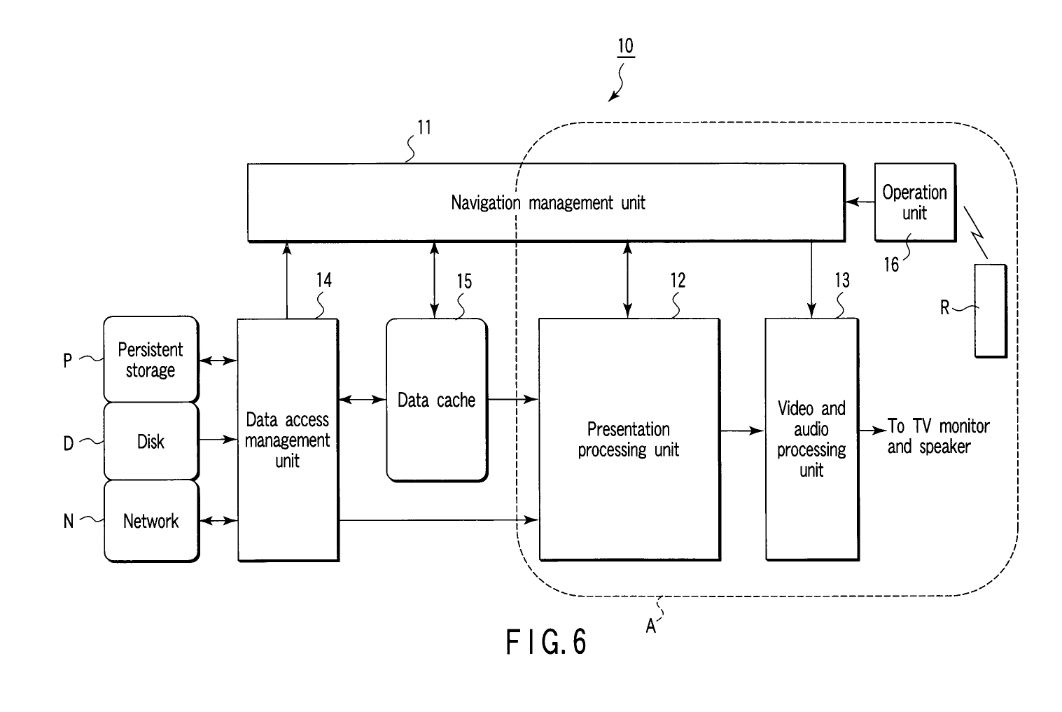

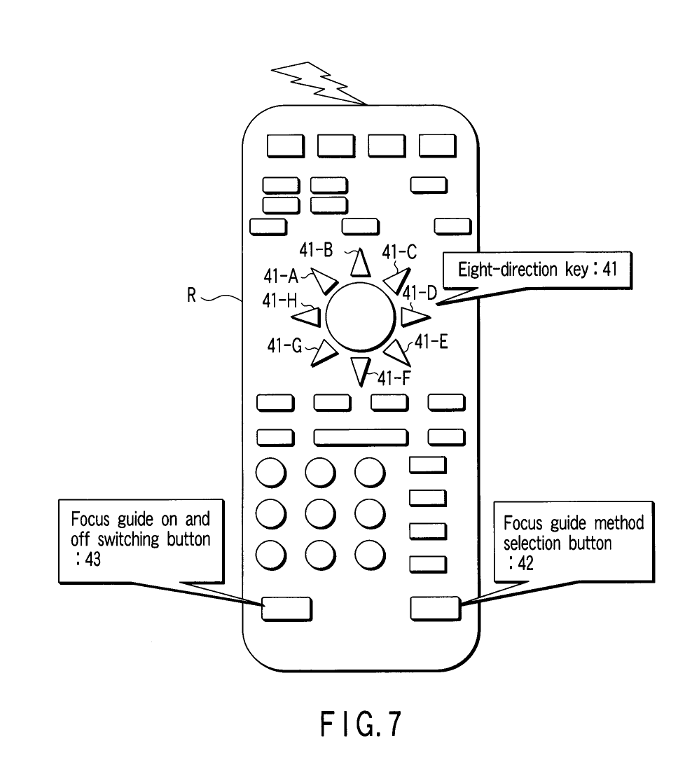

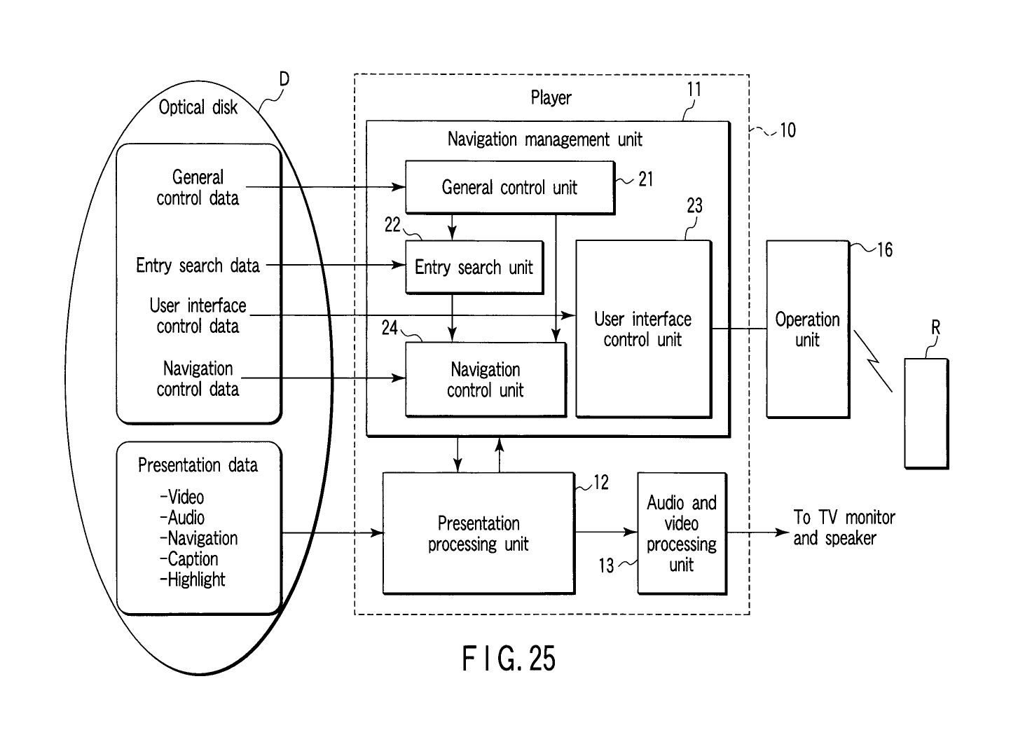

The HD DVD reproducing apparatus 10 includes a navigation management unit 11 which manages the focus guide process, a presentation processing unit 12 which generates a guide signal, a video and audio processing unit 13, a data access management unit 14 which performs recording and reproduction to the optical disk D, and an operation unit 16 associated with a remote controller R. These units will be described later with reference to FIGS. 6 and 25. The remote controller R will be described later with reference to FIG. 7.

Because the two types of contents of the standard contents and the advanced contents are defined in HD DVD, a procedure of distinguishing whether target contents are the standard contents or the advanced contents is performed as a start process when reproducing the contents in the HD DVD reproducing apparatus 10. In the flowchart of FIG. 3, when the optical disk D is loaded (Step S11), the navigation management unit 11 of the HD DVD reproducing apparatus 10 confirms whether or not a file in which an advanced content ID named DISCID.DAT is described exists (Step S12). When the file of DISCID.DAT exist, the navigation management unit 11 determines that the target contents are the advanced contents (Step S13). When the file of DISCID.DAT does not exists, the navigation management unit 11 confirms whether or not standard content ID information named VMG_ID is valid (Step S14). When VMG_ID is valid, the navigation management unit 11 determines that the target contents are the standard contents (Step S15). When VMG_ID is invalid, the navigation management unit 11 determines that the target contents are unknown contents (which are neither the advanced contents nor the standard contents of HD DVD), and an action of the unknown contents depends on the HD DVD reproducing apparatus 10 (Step S16).

Focus Guide Process

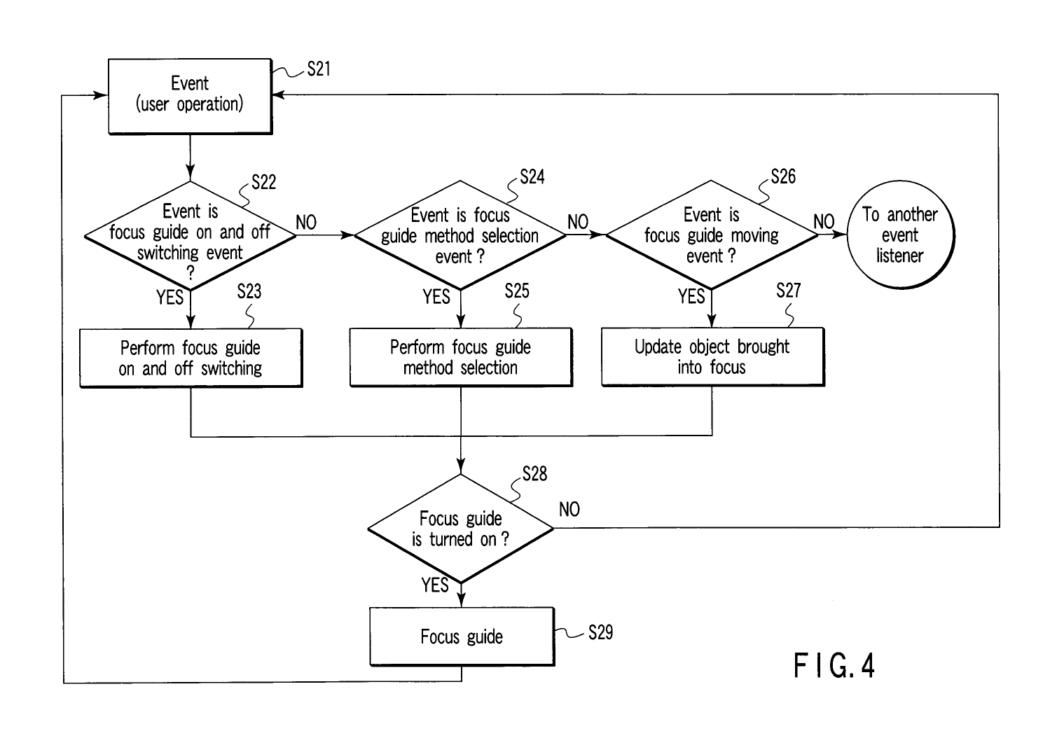

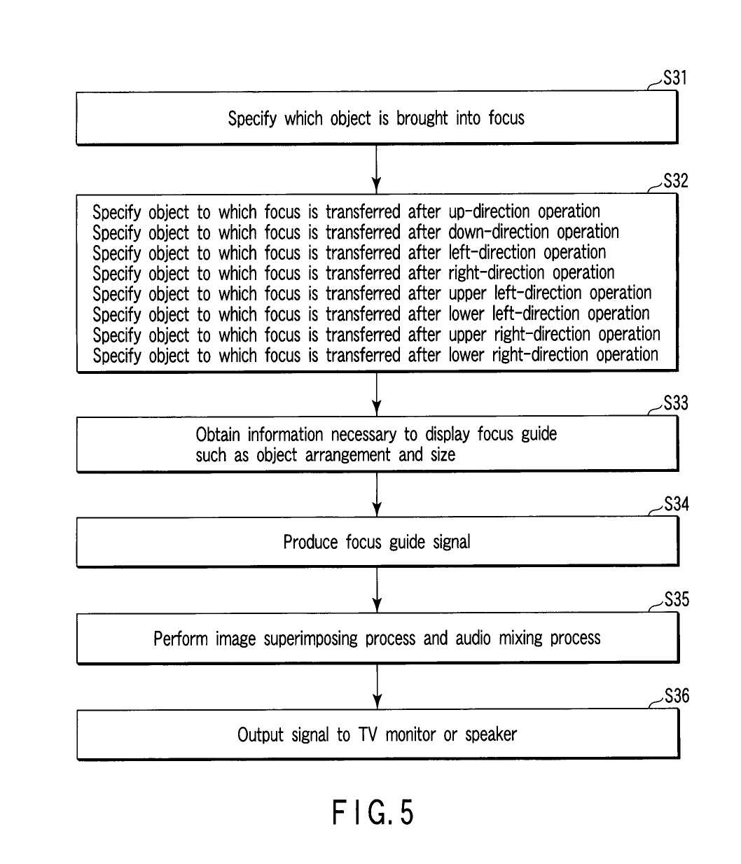

Then, the navigation management unit 11 performs the focus guide process based on the above decision. Although the detailed focus guide process will be described later in the standard contents and the advanced contents, the general outline of the focus guide will be described here. FIG. 4 is a flowchart showing an example of the focus guide process in a standby state for a user operation in the HD DVD reproducing apparatus according to an embodiment of the invention. FIG. 5 is a flowchart showing a schematic example of the focus guide process in the HD DVD reproducing apparatus according to an embodiment of the invention.

The focus guide is the one in which the object currently brought into focus is highlighted and the object to which the focus transits is indicated by eight-direction operation (up, down, right, left, upper right, lower right, upper left, and lower left), thereby assisting a focus moving operation of a user. In HD DVD, as with the website on the Internet, buttons and the like can be arranged on the screen as the user likes. Even if the object arrangement is complicated, the target object can easily be selected by the use of the mouse cursor. However, when the object is selected by moving the focus, the user possibly feels confused in the complicated object arrangement or focus moving rule. Therefore, even in the complicated object arrangement or focus moving rule, the focus can smoothly be moved to the target object by displaying an arrow or performing audio guidance if needed.

The focus guide process in the standby state for the user operation will be described with reference to the flowchart of FIG. 4. The flowchart of FIG. 4 starts from generation of an event of the user operation (Step S21). The user operation associated with the focus guide includes an operation of selecting whether a focus guide function is enabled with a focus guide on and off switching button 43 of the later-mentioned remote controller R, an operation for selecting how the focus guide is performed with a focus guide method selection button 42 (options such as arrow display and audio guidance are provided), and an operation for performing the focus movement with a direction key 41. Other user operations except for the above three operations are not correlated with the focus guide, and already existing other event listeners of the HD DVD reproducing apparatus 10 perform the process of other user operations.

The navigation management unit 11 confirms whether or not the event by the user operation is a focus guide on and off switching event (Step S22). When the event by the user operation is the focus guide on and off switching event, the navigation management unit 11 reflects the selection (Step S23). When the event by the user operation is not the focus guide on and off switching event, the navigation management unit 11 confirms whether or not the event by the user operation is a focus guide method selection event (Step S24). When the event by the user operation is the focus guide method selection event, the navigation management unit 11 reflects the selection (Step S25). When the event by the user operation is not the focus guide method selection event, the navigation management unit 11 confirms whether or not the event by the user operation is a focus moving event (Step S26). When the event by the user operation is the focus moving event, the navigation management unit 11 moves the focus according to a focus transition rule (updates the object brought into focus) (Step S27). When the event by the user operation is not the focus moving event, the process is transferred to another event listener. The three event confirming processes can be performed in no particular order.

The navigation management unit 11 determines whether or not the focus guide is turned on (Step S28). When the focus guide is turned on, the flow goes to the focus guide process (Step S29). When the focus guide is turned off, the flow returns to the standby state for the event (Step S21).

In the focus guide process, as shown in the flowchart of FIG. 5, the navigation management unit 11 specifies which object is brought into focus (Step S31). Then, the navigation management unit 11 specifies where the focus is transferred by the eight-direction operation of the direction key such as the remote controller R (Step S32). That is, the navigation management unit 11 specifies the object to which the focus is transferred after the up-direction operation, specifies the object to which the focus is transferred after the down-direction operation, specifies the object to which the focus is transferred after the right-direction operation, specifies the object to which the focus is transferred after the left-direction operation, specifies the object to which the focus is transferred after the upper left-direction operation, specifies the object to which the focus is transferred after the lower left-direction operation, specifies the object to which the focus is transferred after the upper right-direction operation, and specifies the object to which the focus is transferred after the lower right-direction operation.

Although described later in detail, the focus moving rule is clearly defined in the HD DVD standard, and the content creator can set a destination of the focus movement as the content creator likes. Therefore, computation is performed based on the focus moving rule to specify the object brought into focus and the object to which the focus is transferred.

When the object brought into focus and the object to which the focus is transferred can be specified, the presentation processing unit 12 obtains pieces of information on the object arrangement and an object size (Step S33). The presentation processing unit 12 generates detailed information according to the focus guide method selected by the user (Step S34). The detailed information (referred to as focus guide signal) has such levels how the focus guide is specifically expressed (for example, because the object brought into focus is a 400×100 button having a start point (100px, 100px), a yellow frame is displayed around 3px of the button).

Then, the video and audio processing unit 13 performs a process for superimposing a focus guide video signal and a usual video signal, and a process for mixing a usual audio signal and a focus guide audio signal (Step S35). The video and audio processing unit 13 transmits the focus guide signal to a TV monitor or a speaker in the form of the video signal or audio signal, thereby outputting the focus guide signal in the form of the arrow display or audio guidance (Step S36). The general outline of the focus guide process has been described above.

<Detailed Description of Focus Guide Process in Reproducing Advanced Contents>

Then, the focus guide process performed by the HD DVD reproducing apparatus 10 in reproducing the advanced contents will be described in detail with reference to the drawings.

(Configuration of HD DVD Reproducing Apparatus in Reproducing Advanced Contents)

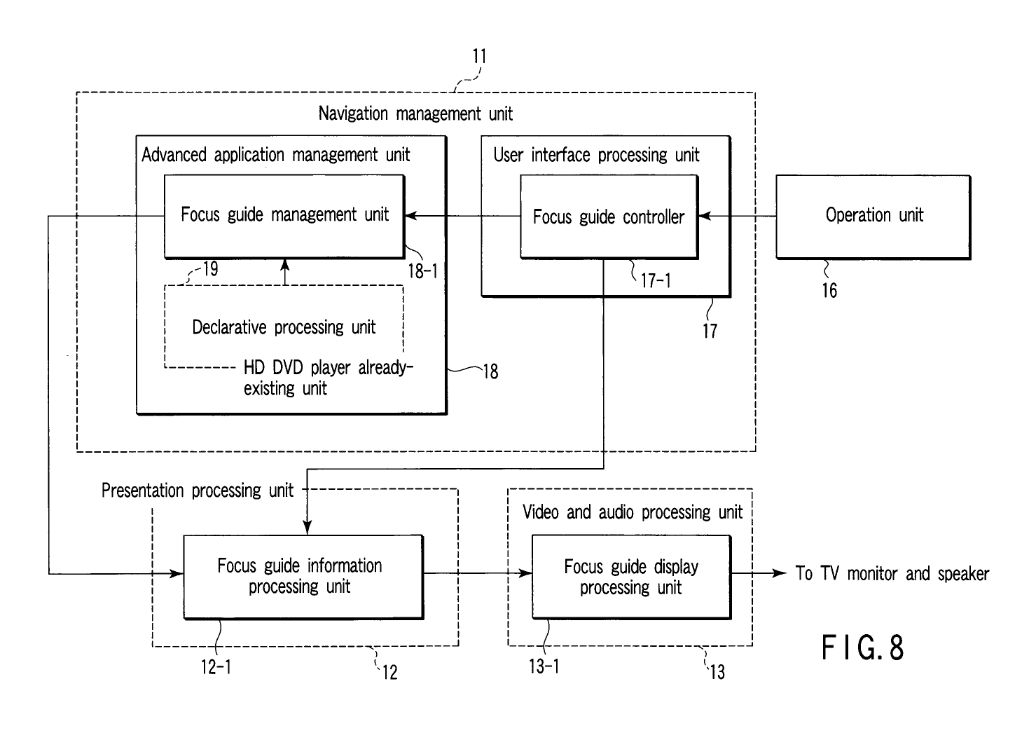

A configuration example of a processing unit in the HD DVD reproducing apparatus 10 in reproducing the advanced contents will first be described with reference to the drawings. FIG. 6 is a block diagram showing a configuration example of the HD DVD reproducing apparatus according to an embodiment of the invention. FIG. 7 is an appearance view showing an example of a remote controller used in the HD DVD reproducing apparatus according to an embodiment of the invention. FIGS. 8 to 13 are block diagrams showing a configuration example for performing the focus guide process in the HD DVD reproducing apparatus according to an embodiment of the invention.

As shown in FIG. 6, the HD DVD reproducing apparatus 10 includes the navigation management unit 11 which manages the focus guide process and the reproducing process and the presentation processing unit 12 which generates the guide signal. The HD DVD reproducing apparatus 10 also includes the video and audio processing unit 13, the data access management unit 14, a data cache 15, and the operation unit 16. The video and audio processing unit 13 performs processes such as a scale conversion process and a video correction process to the video and audio signals. The data access management unit 14 reads content information stored in the optical disk D or record the data, when the optical disk D is loaded to read the light reflected from the optical disk D by the laser beam irradiation. A scan signal scanned from the optical disk D is stored in the data cache 15. The operation unit 16 is associated with a remote controller R shown in FIG. 7.

As shown in FIG. 7, the remote controller R includes an eight-direction key 41, i.e., an upper left-direction key 41-A, an up-direction key 41-B, an upper right-direction key 41-C, a right-direction key 41-D, a lower right-direction key 41-E, a down-direction key 41-F, a lower left-direction key 41-G and a left-direction key 41-H. The remote controller R also includes the focus guide method selection button 42 and the focus guide on and off switching button 43.

The general outline of a process for reproducing the advanced contents will be described as the basic action of the HD DVD reproducing apparatus 10 having the above configuration.

In the advanced contents, the HD DVD reproducing apparatus 10 can read the data from the persistent storage P (tentative storage memory) and the network N in addition to the optical disk D. The pieces of data pursuant to the HD DVD format, stored in the data sources, are distributed to the navigation management unit 11, the data cache 15, and the presentation processing unit 12 through the data access management unit 14.

The navigation management unit 11 is the one which controls the reproduction. The navigation management unit 11 obtains a reproduction control file, described in XML or ECMA Script, from the data access management unit 14. Sometimes the navigation management unit 11 obtains the reproduction control file indirectly after the reproduction control file is tentatively loaded on the data cache 15.

The navigation management unit 11 interprets contents of the reproduction control file described in XML or ECMA Script. The navigation management unit 11 outputs a command to the presentation processing unit 12 based on the interpreted reproduction control information, and the command is utilized in the reproduction control.

The navigation management unit 11 receives the user operation such as a button operation of the remote controller R, and processes the user operation into a reproduction control command to output the command to the presentation processing unit 12. The data cache 15 is a memory in which the data used in the reproduction is tentatively stored.

The presentation processing unit 12 determines which video or audio is actually outputted from the reproduction control command or the data used in the reproduction, and the presentation processing unit 12 converts the video data and audio data into information which can be used in the reproduction. Because the video and the audio are multiplexed in the reproduction data stored in the optical disk, the reproduction data cannot directly be utilized. Therefore, the presentation processing unit 12 selects the video data and audio data necessary for the reproduction to perform a demux process for returning the multiplexed data to the original data.

Because the data produced by the demux process is encoded in various CODECs, the data is decoded. The presentation processing unit 12 sequentially outputs reproduction data to the video and audio processing unit 13 based on the decoded data and the reproduction control command from the navigation management unit 11.

The video and audio processing unit 13 receives the reproduction data to perform the image superimposing process and the audio mixing process. The video image and audio are outputted from the TV monitor and speaker according to the video signal and audio signal which are outputted from the video and audio processing unit 13.

(Configuration of Focus Guide of HD DVD Reproducing Apparatus in Reproducing Advanced Contents)

Then, the focus guide of the HD DVD reproducing apparatus 10 in reproducing the advanced contents will be described with reference to FIGS. 8 to 14. FIGS. 8 to 14 are block diagrams showing a configuration example for performing the focus guide process in the HD DVD reproducing apparatus according to an embodiment of the invention.

As shown in FIG. 8, the HD DVD reproducing apparatus 10 includes five new configurations in order to perform the focus guide process according to an embodiment of the invention. The navigation management unit 11 includes a user interface processing unit 17 and an advanced application management unit 18. The user interface processing unit 17 includes a focus guide controller 17-1, and the advanced application management unit 18 includes a focus guide management unit 18-1 and a declarative processing unit 19. The presentation processing unit 12 includes a focus guide information processing unit 12-1, and the video and audio processing unit 13 includes a focus guide display processing unit 13-1.

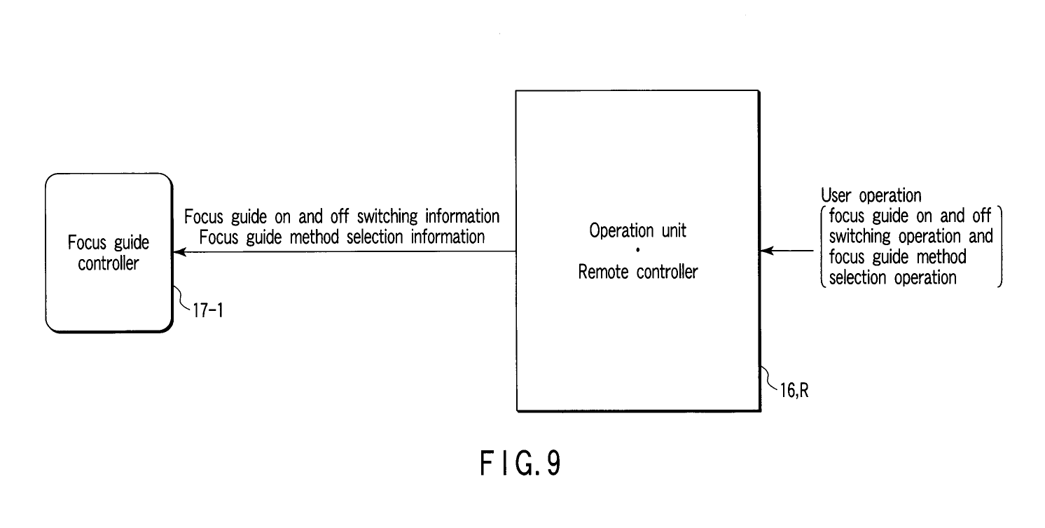

The new units will be described sequentially with reference to FIGS. 9 to 13. As shown in FIG. 9, the operation unit 16 and the remote controller R are a user interface for the focus guide. Using the selection buttons 42 and 43, the operation unit 16 and the remote controller R select whether or not the user uses the focus guide function and select which guide is utilized (a method for displaying a moving destination with an arrow or a method for performing guidance with the audio) when the user uses the focus guide function, and the operation unit 16 and the remote controller R supply a user selection signal to the focus guide controller 17-1. The operation unit 16 includes an operation switch (not shown) provided in a main body of the HD DVD reproducing apparatus 10, and has a function of communicating with the remote controller R shown in FIG. 7. The operation may be performed with the operation unit 16 and the direction key 41 of the remote controller R, or may be performed using audio input.

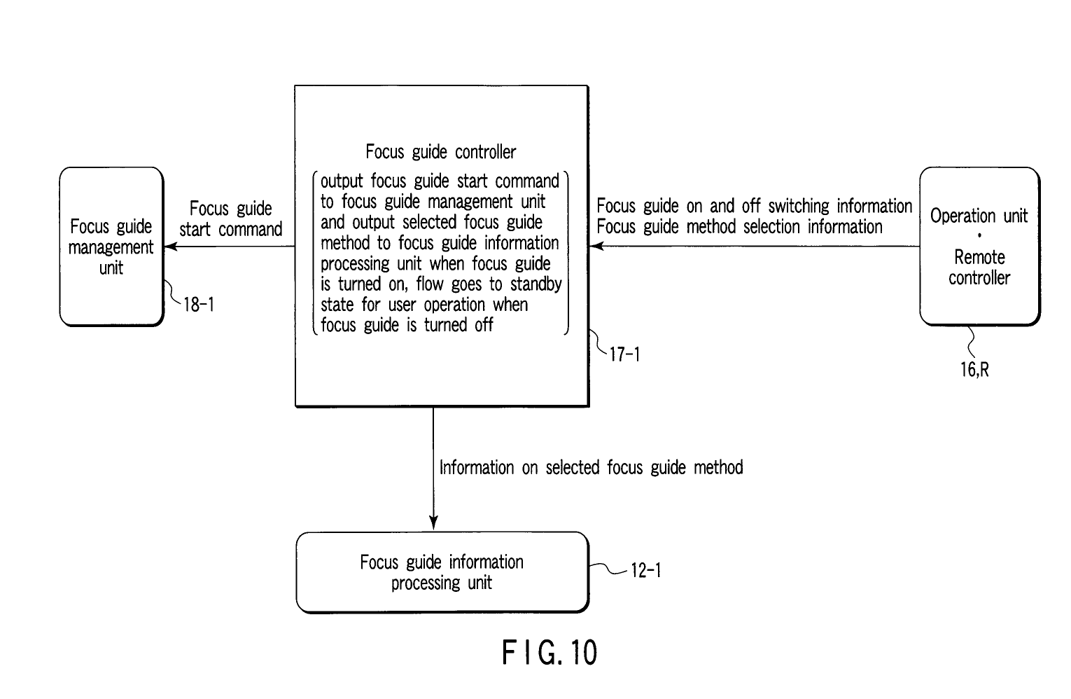

As shown in FIG. 10, the focus guide controller 17-1 branches the following process according to the user selection signal supplied from the operation unit 16 and the remote controller R. When the user selects “use focus guide” by operating the focus guide on and off switching button 43 of the remote controller R, the focus guide controller 17-1 outputs a command for starting the focus guide process to the focus guide management unit 18-1 and outputs information indicating the focus guide method selected by the user to the focus guide information processing unit 12-1. When the user selects “use no focus guide”, the focus guide is not performed, and the flow returns to the standby state for the user operation.

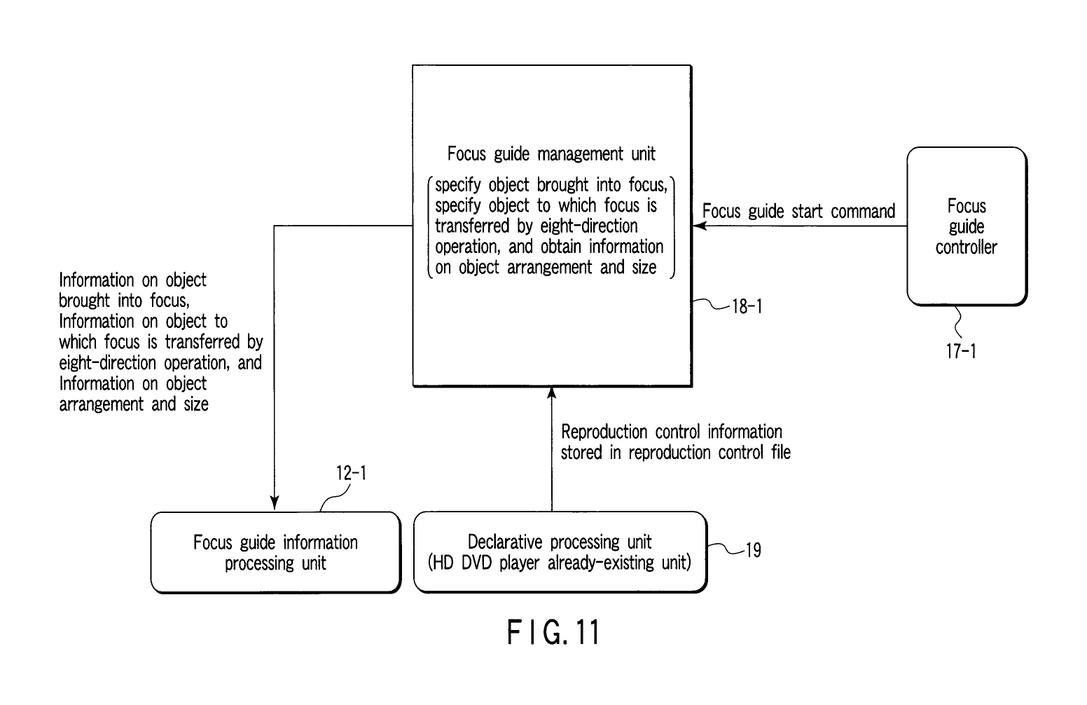

As shown in FIG. 11, the focus guide management unit 18-1 specifies the object currently brought into focus by obtaining an attribute signal from the declarative processing unit 19, and determines the object to which the focus is moved by the eight-direction operation. The focus guide management unit 18-1 also obtains information, such as the object arrangement and size, which is necessary to display the focus guide.

The declarative processing unit 19 manages the transition of information on an attribute that the object brought into focus is in a focused state based on the content information from the optical disk D and the operation signal from the operation unit 16.

That is, a value of the attribute that the object brought into focus is in the focused state becomes “true”, and two or more objects are not simultaneously brought into focus. Accordingly, the focus guide management unit 18-1 obtains the focused state value managed by the declarative processing unit 19, and specifies the object brought into focus based on the focused state value.

In order to specify the object to which the focus is transferred by the eight-direction operation, the focus guide management unit 18-1 interprets contents of files such as Playlist, Manifest, Markup, and Script which are the reproduction control information of HD DVD advanced contents described in XML or ECMA Script.

In the HD DVD standard, the rule concerning the focus movement is strictly defined, and the destination object can be specified by interpreting the reproduction control file. Similarly, the information on the object arrangement and size can be obtained by interpreting the reproduction control file. The pieces of information specified by the focus guide management unit 18-1 (information on the object brought into focus, information on the destination object, and information on the object arrangement) are supplied to the focus guide information processing unit 12-1 described later.

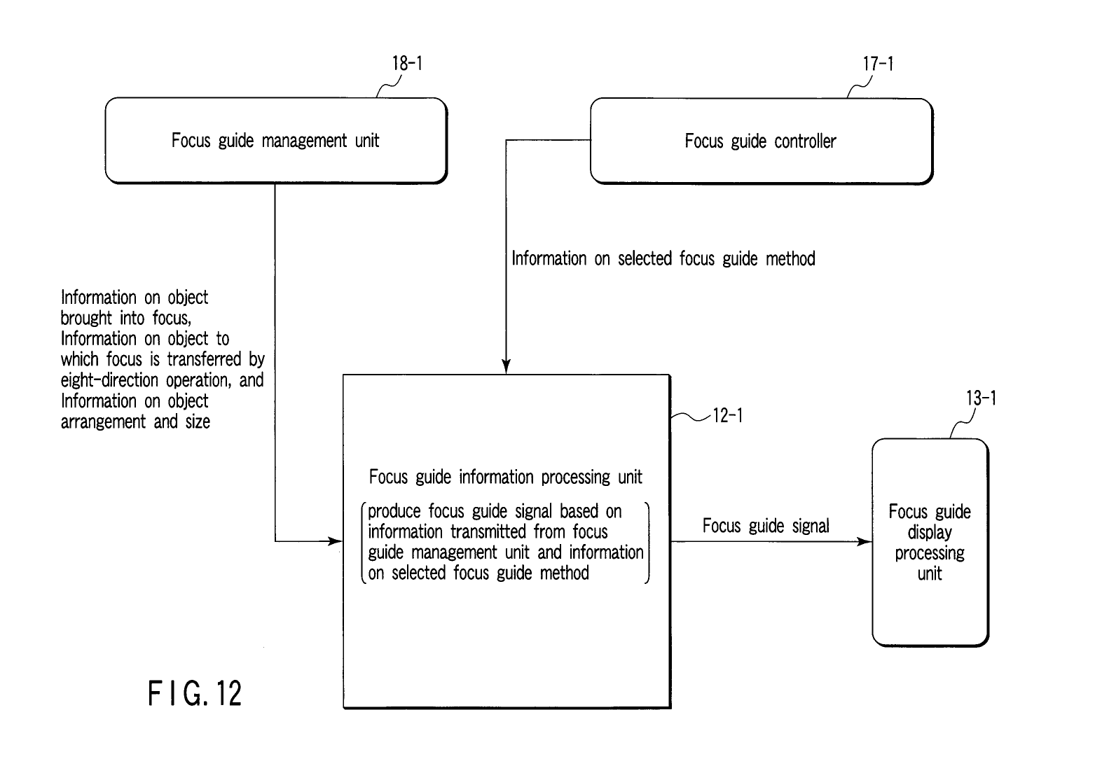

As shown in FIG. 12, the focus guide information processing unit 12-1 generates specific information (focus guide signal) used in the focus guide output to output the specific information to the focus guide display processing unit 13-1 described later based on the information sent from the focus guide management unit 18-1 and the information on the focus guide method selected by the user.

The contents of the focus guide signal are the specific video or audio information such as “arrow having a start point (400,200) is displayed as graphic”.

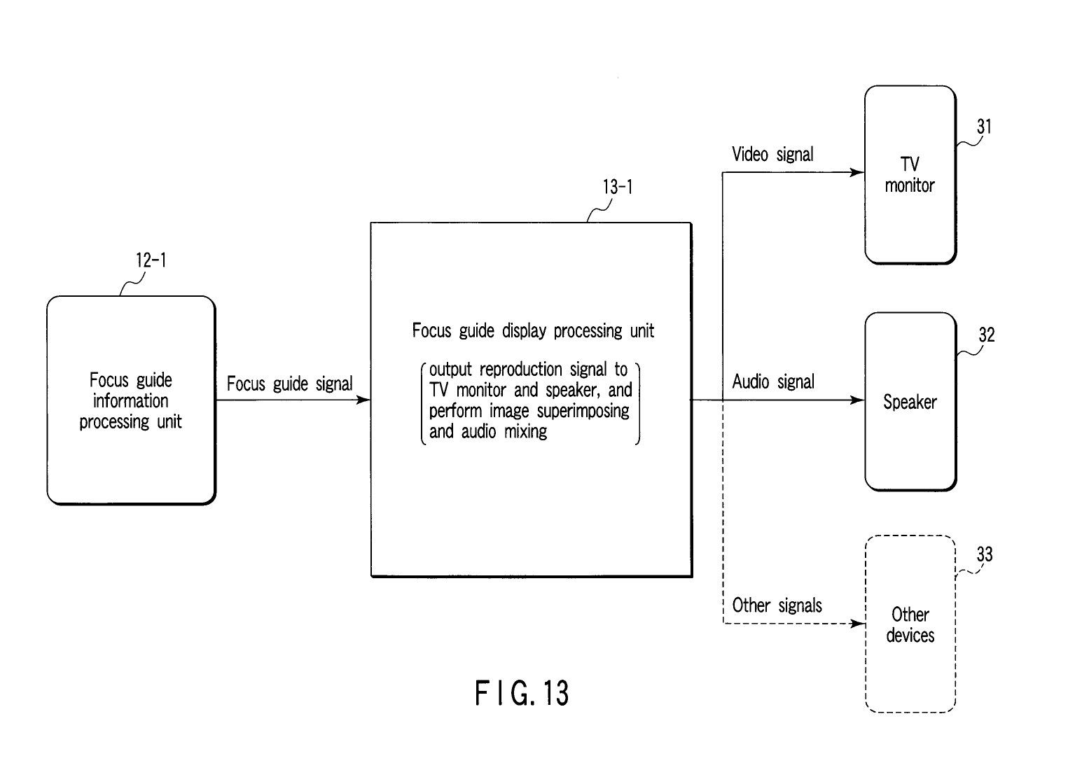

As shown in FIG. 13, the focus guide display processing unit 13-1 obtains the focus guide signal from the focus guide information processing unit 12-1, and supplies the video signal and the audio signal to the TV monitor or the speaker.

In the case where the graphic output is used, the focus guide display processing unit 13-1 may be incorporated into an already-existing processing unit for the graphic output (graphic rendering processing unit) or an independent plane (focus guide plane) may be prepared to mount a mechanism in which the plane is displayed on the foreground.

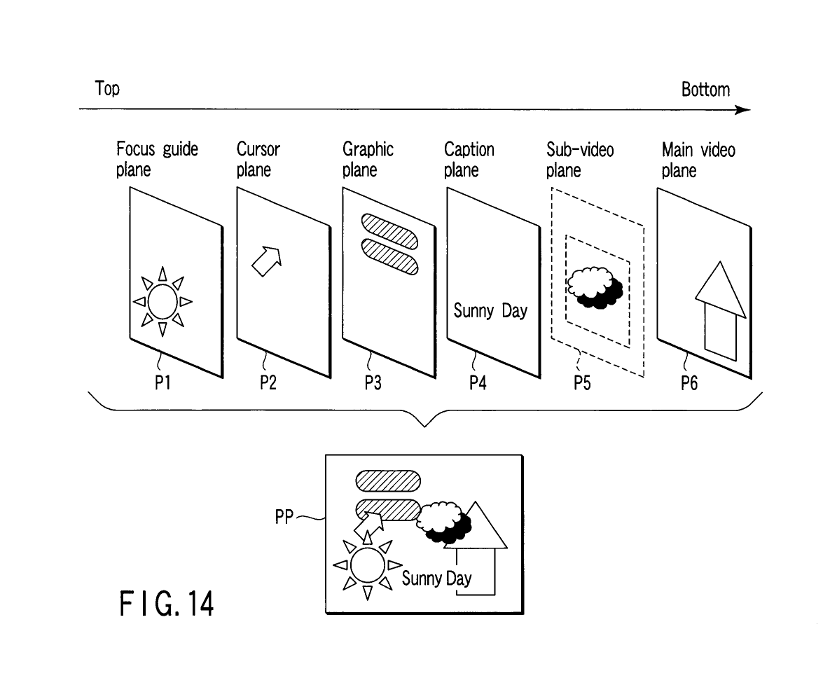

That is, as shown in FIG. 14, the focus guide display processing unit 13-1 generates a composite image PP by combining plural planes such as a focus guide plane P1, a cursor plane P2, a graphic plane P3, a caption plane P4, a sub-video plane P5, and a main video plane P6. Preferably the image is displayed on the TV monitor 31 as if the superimposed plural planes are viewed from above.

On the other hand, in the case of the audio output, the method for turning off all the pieces of audio except for the audio guidance is preferably adopted. Preferably a mechanism of audio mixing (audio superposition) is introduced to output the audio for the focus guide in addition to the usual audio.

As described above with reference to the drawings, the HD DVD reproducing apparatus 10 includes the five new configurations (focus guide controller 17-1, focus guide management unit 18-1, declarative processing unit 19, focus guide information processing unit 12-1, and focus guide display processing unit 13-1) of FIG. 8 to perform the focus guide process according to an embodiment of the invention by operating these new units.

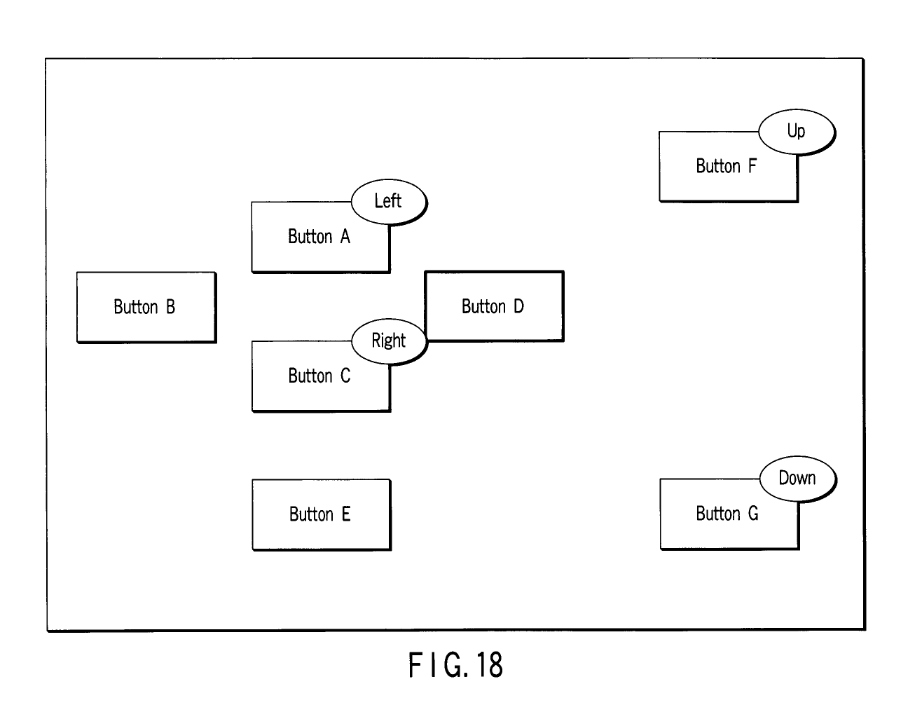

Particularly the focus guide plane P1 which is the object focus information is generated and display on the screen. Therefore, as described later in detail with reference to FIGS. 18 and 22 to 24, a function of displaying which object is currently brought into focus and a function of predicting where the focus is transferred by operating the direction key 41 of the remote controller R are provided.

(Focus Guide Process in HD DVD Reproducing Apparatus in Reproducing Advanced Contents)

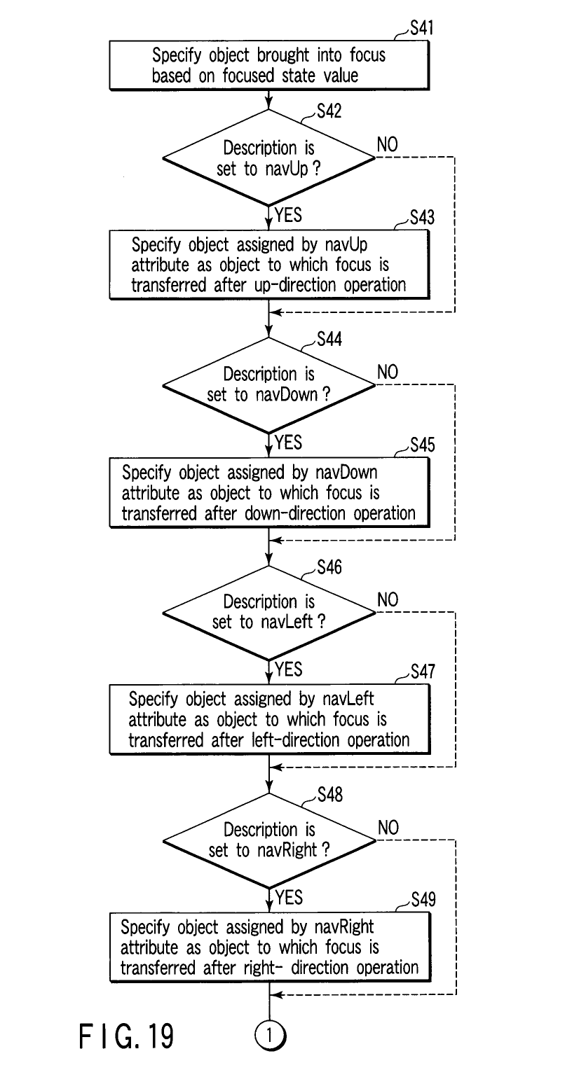

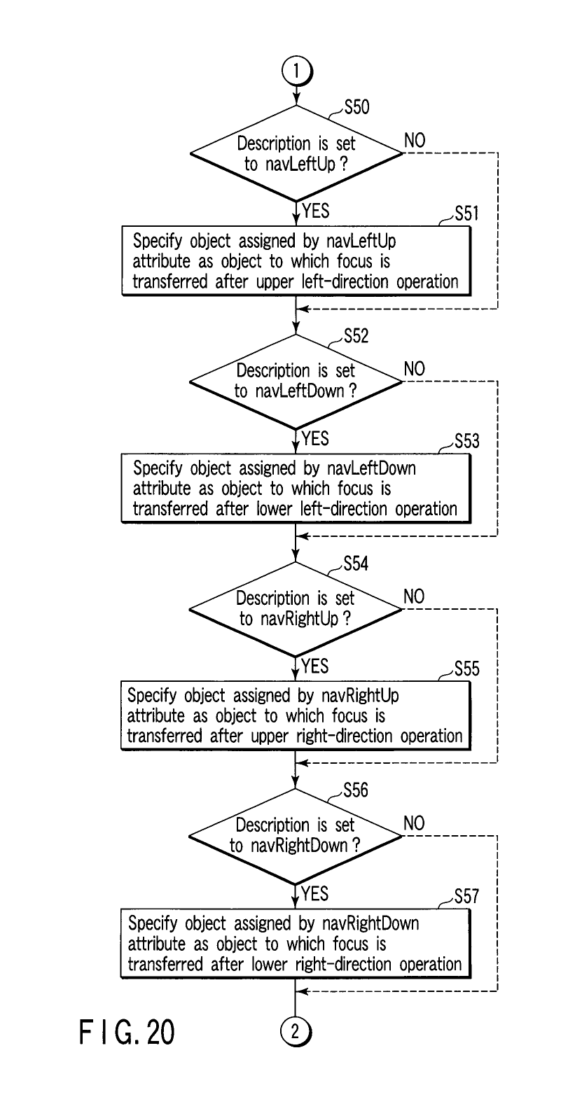

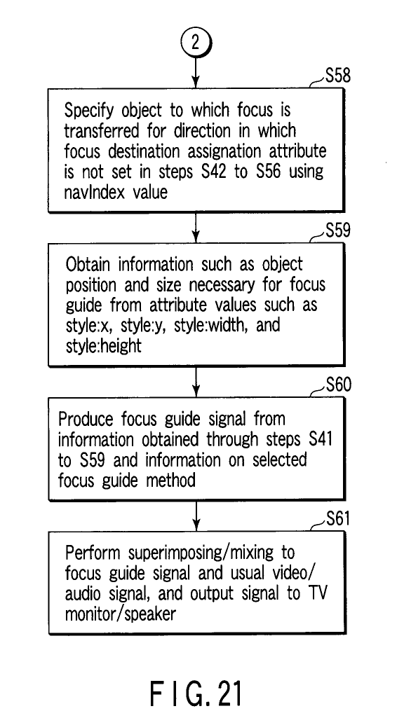

Then, a function of highlighting the object brought into focus and a function of predicting where the focus is transferred will be described in detail with reference to display screens of FIGS. 18 and 22 to 24 and flowcharts of FIGS. 19 to 21.

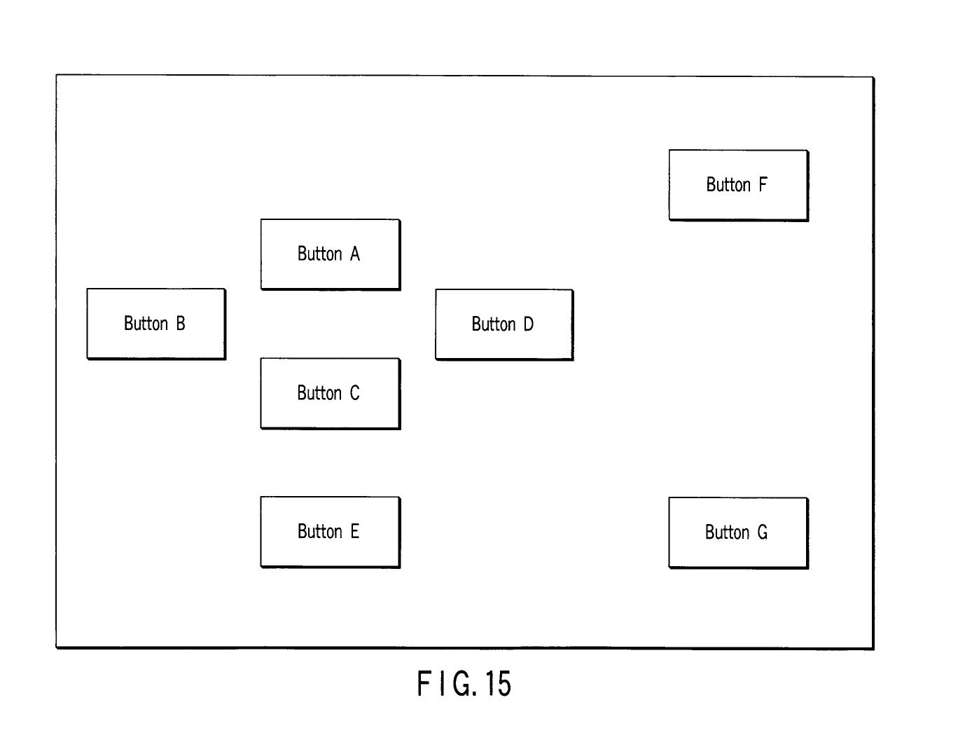

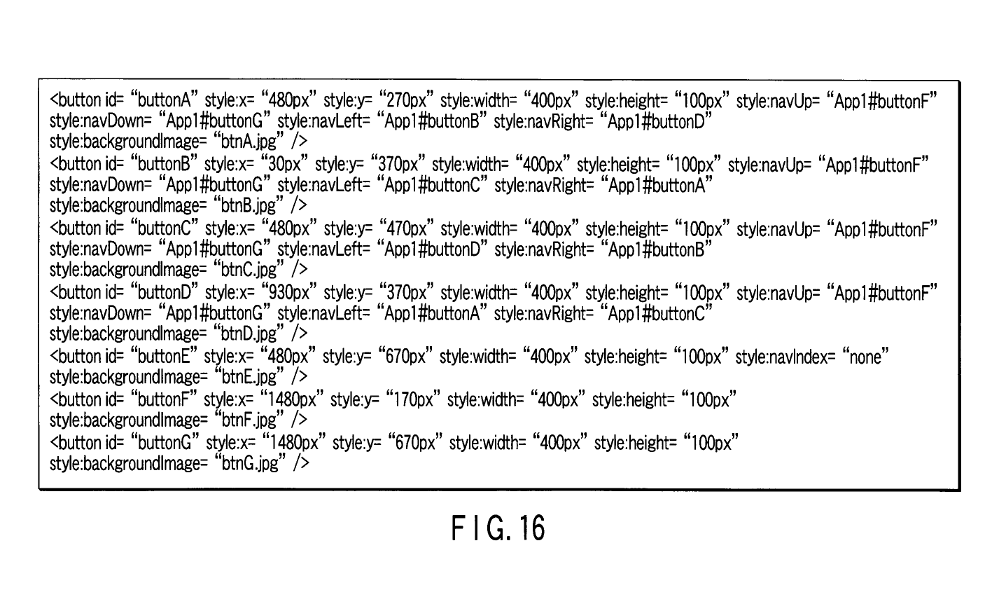

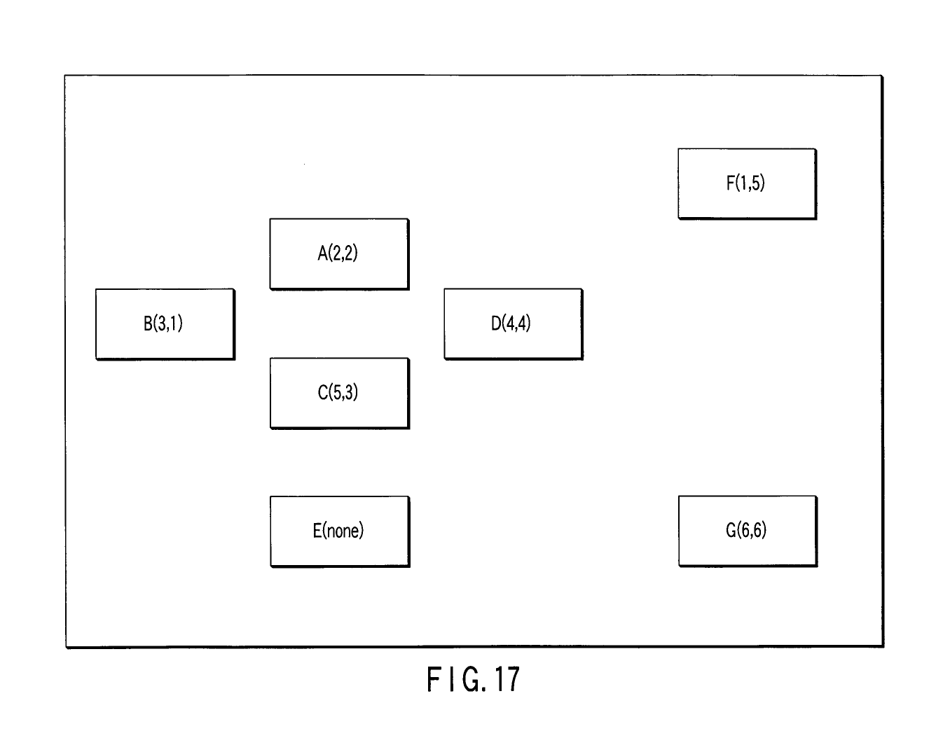

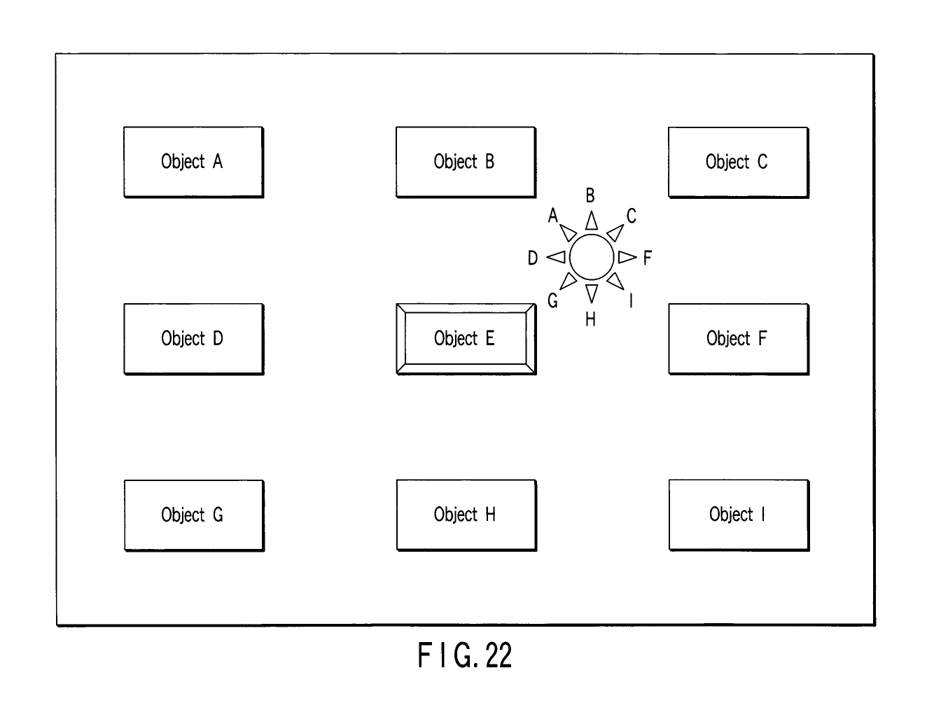

FIG. 15 is an explanatory view showing an example of the object arrangement in the HD DVD reproducing apparatus according to an embodiment of the invention. FIG. 16 is an explanatory view showing an example of Markup setting, FIG. 17 is an explanatory view showing an example of navIndex setting, and FIG. 18 is an explanatory view showing an example of the focus guide. FIGS. 19 to 21 are flowcharts showing an example of the focus guide process performed to the advanced contents. FIGS. 22 to 24 are explanatory views showing an example of the focus guide.

As shown in the flowchart of FIG. 19, in the HD DVD reproducing apparatus 10, the declarative processing unit 19 manages the object brought into focus based on the value of the focused state attribute value. Two or more objects brought into focus do not exist, only the object brought into focus has the focused state value of “true”, and the other objects have the focused state value of “false”. Accordingly, the focus guide management unit 18-1 confirms the focused state values of the objects to specify the “true” object having the focused state value of “true” as the object brought into focus (Step S41).

The pieces of attribute information such as the object arrangement and background color are written in the reproduction control file called Markup described in the XML language, and the focused state attribute can also be set as one of the pieces of attribute information. For example, some button can be brought into focus by describing that the focused state value is “true” in the button. However, this means an initial value. Because the focus is transferred by the user operation, the focused state value is updated when the focus is moved.

Then, the focus guide management unit 18-1 specifies the object to which the focus is transferred. That is, the focus guide management unit 18-1 specifies where the focus is transferred by operating the eight-direction key 41 of the remote controller R. Because the focus transition rule is strictly defined in the HD DVD standard, the computation is performed pursuant to the rule to specify in advance the object to which the focus is transferred.

FIG. 16 partially shows an abstract of the reproduction control file called Markup described in the XML language. However, one unrelated with the focus guide is omitted for the purpose of simple explanation. The pieces of information such as the object arrangement which are pasted on the screen are written in the Markup. In the case where the Markup is described as shown in FIG. 16, seven buttons are arranged on the screen as shown in FIG. 15.

The pieces of information related with the focus transition mainly include the object arrangement on the screen, a value of style: navIndex, and a destination assignation attribute (style: navUp/navDown/navLeft/navRight/navLeftUp/navLeftDown/navRightUp/navRightDown)

The focus guide management unit 18-1 confirms the destination assignation attribute of the object currently brought into focus from the reproduction control file called Markup. That is, the focus guide management unit 18-1 refers to the description concerning the object currently brought into focus from the reproduction control file called Markup shown in FIG. 16, and the focus guide management unit 18-1 determines whether or not navUp is set to the description (Step S42). When navUp is set to the description, the focus guide management unit 18-1 specifies the object assigned by the navUp attribute as the object to which the focus is transferred after the scan is performed upward (Step S43). When navUp is not set to the description, the flow skips a process of Step S43 to move to a determination process of Step S44.

Similarly, the focus guide management unit 18-1 refers to the description concerning the object currently brought into focus from the reproduction control file called Markup, and sequentially determines whether or not navDown, navLeft, navRight, navDown, navLeftUp, navLeftDown, navRightUp, and navRightDown are set to the description (Steps S44, S46, S48, S50, S52, S54, and S56).

When navDown, navLeft, navRight, navDown, navLeftUp, navLeftDown, navRightUp, and navRightDown are set to the description, the focus guide management unit 18-1 specifies the object assigned by the navDown, navLeft, navRight, navDown, navLeftUp, navLeftDown, navRightUp, and navRightDown attributes as the object to which the focus is transferred after the scan is performed upward (Steps S45, S47, S49, S51, S53, S55, and S57). When navDown, navLeft, navRight, navDown, navLeftUp, navLeftDown, navRightUp, and navRightDown are not set to the description, the flow skips a process of specifying the object to which the focus is transferred, and the flow moves to a next determination process.

The destination assignation attribute includes a definition that “when the object is brought into focus, the focus is transferred to an XX object by a YY direction operation”. In the case where the destination assignation attribute is set, the highest priority is given to the setting in the focus transition.

In the embodiment, because the navLeft=“Appl#buttonB” and navRight=“Appl#buttorD” are set to a button A. Therefore, in the case where the button A is brought into focus, the focus is transferred to a button B when the left-direction operation is performed, and to a button D when the right-direction operation is performed.

The focus guide management unit 18-1 specifies the object to which the focus is transferred based on the navIndex value (Step S58). That is, the destination object in the direction in which the destination assignation attribute is not set is specified based on the value called navIndex. The navIndex is formed by a pair of positive integral parameters. The right-direction operation means “the focus is transferred to the object whose first parameter has the second largest value” when compared with the pair of parameters, the left-direction operation means “the focus is transferred to the object whose first parameter has the second smallest value”, the down-direction operation means “the focus is transferred to the object whose second parameter has the second largest value”, and the up-direction operation means “the focus is transferred to the object whose second parameter has the second smallest value”.

The navIndex value can expressly be set to each object by the Markup. For example, letting style: navIndex=“3,4” sets the object to the navIndex value (3,4). When the navIndex value is not expressly set by the Markup, the navIndex value is automatically allocated to all the objects based on x and y coordinates of the start point (upper-left point) of the arranged object. The setting of style: navIndex=“none” means that the focus is not transferred to the object, and the pair of positive integers as navIndex is not allocated to the object.

In the Markup shown in FIG. 16, style: navIndex=“none” is set to only a button E, and style: navIndex=“none” is not set to other objects. Accordingly, the navIndex value is set as shown in FIG. 17. When the button A is currently brought into focus, the focus transferred based on the navIndex value (unless the destination assignation attribute is set) is moved like A→C→D→F→G→B→A, . . . by the down-direction operation. However, the above result is not obtained because the destination assignation attribute is set to the buttons A, B, C, and D in the Markup shown in FIG. 16. In the standard, because the destination assignation attribute has the higher priority than the navIndex value, the object is specified by the computation based on the navIndex value only in the case of the object to which the focus is transferred in the direction which is not specified in Steps S42 to S57.

The focus transition is performed pursuant to the above rule, so that the next object to which the focus is transferred can be specified in advance from the navIndex value and the destination assignation attribute.

Obtainment of Information Necessary for Focus Guide

Although the minimum information necessary for the focus guide can be obtained through Steps S41 to S58, sometimes other pieces of information are obtained depending on the focus guide method. For example, like the focus guide of FIG. 18, in the case of adopting a focus guide method for displaying an edge around the object brought into focus to highlight the object or a focus guide method for displaying “which operation is performed to move the focus to the object” on the upper right of the objects to which the focus is transferred, information on “the position and size of the object brought into focus” and information on “the position and size of the object to which the focus is transferred” are additionally required.

In such cases, the focus guide management unit 18-1 determines the information of the object position from the values of the style: x and style: y, and determines the size information from the values of the style: width and the style: height (Step S59). Although the detailed description is omitted, because the function of specifying the position and size is essential for the already-existing HD DVD reproducing apparatus 10, it is preferable to use the information obtained from the already-existing HD DVD reproducing apparatus 10.

Production of Focus Guide Signal

All the pieces of information necessary for the focus guide are obtained through Steps S41 to S59. Then, the focus guide information processing unit 12-1 produces the focus guide signal based on the pieces of information and the focus guide method selected by the user (Step S60). In the focus guide of FIG. 18, the 6pt black edge is displayed around the object brought into focus, and which direction operation is performed to transfer the focus to the object is displayed in the upper-right corner portions of the objects to which the focus is transferred. Thus, the focus guide information processing unit 12-1 determines the detailed focus guide and sequentially transmits the reproduction signal to the focus guide display processing unit 13-1.

Image Superimposing/Audio Mixing to Output

In the final step of the focus guide, the focus guide display processing unit 13-1 generates the focus guide plane based on the reproduction signal received from the focus guide information processing unit 12-1.

In the focus guide of FIG. 18, the focus guide is realized by highlighting the edge of the object brought into focus and by displaying the operation for transferring the focus to the object in the upper right portions of the objects to which the focus is transferred. In order to realize the guidance performed by the display, the focus guide display processing unit 13-1 uses the image superimposing of FIG. 14 and outputs the image superimposing to the TV monitor.

At this point, the focus guide plane may independently be prepared, or the focus guide plane may be incorporated into the graphic plane. Furthermore, the focus guide plane may be incorporated into the cursor plane. Preferably, in the focus guide plane, at least color information on the object displayed on the screen, character information for specifying the object, moving image information on the object, or audio information for specifying the object is generated in order to inform the user of the object brought into focus.

Although it is not necessary in this example, in the case where the audio guidance is used, usually the focus guide is outputted to the speaker after the audio mixing. At this point, the method for completely turning off all the pieces of audio except for the audio guidance to output focus guide audio may be adopted, or the method for mixing and outputting the focus guide and the usual audio except for the focus guide and the audio mixing (audio superposition) may be adopted. The detailed processes of the focus guide will be described above.

(Other Examples of Focus Guide)

The focus guide is not limited to the displays shown in the above examples, but any form can be used as the focus guide as long as the focus guide can assist the focus operation of the user. FIGS. 22 to 24 show other examples of the focus guide.

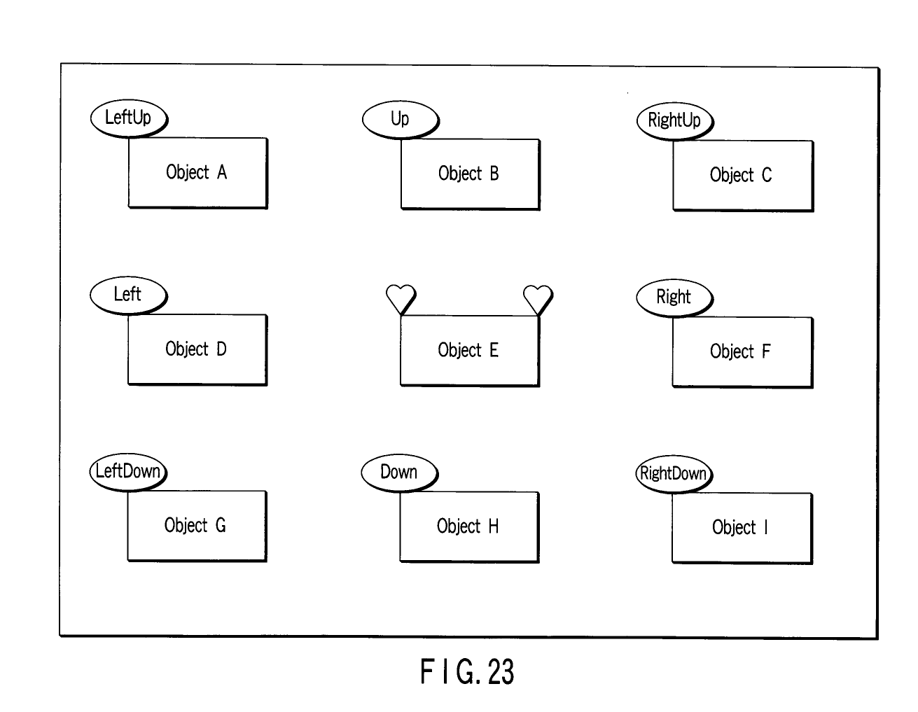

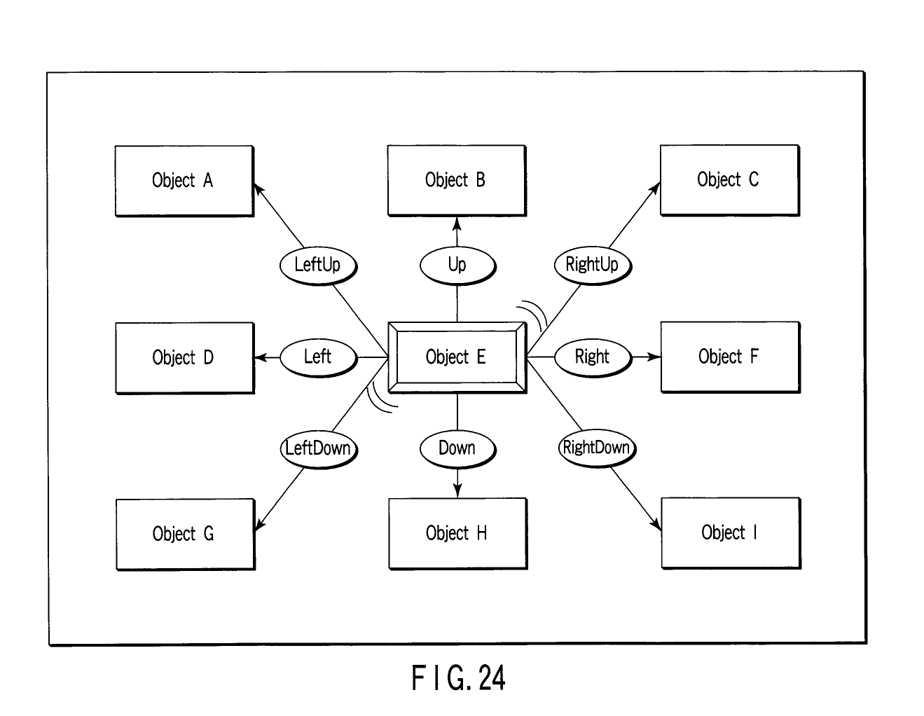

In the focus guide shown in FIG. 22, the edge of the object brought into focus is highlighted and the object to which the focus is transferred is indicated by the eight-direction arrow. In the focus guide shown in FIG. 23, signs (heart marks) are displayed in the object brought into focus, and which direction operation is performed to transfer the focus to the object is displayed on the upper left portions of the objects to which the focus is transferred. In the focus guide shown in FIG. 24, the object to which the focus is transferred is indicated using an arrow connector.

A transmittance in the focus guide display portion may be changed, and a mechanism for making the distinction by color may be adopted. A background image of the object may be changed, or the audio guidance may be used instead of the display. A form in which both the video and audio are used such that the button flashes with the audio that “the focus is transferred to the button when the right-direction operation is performed” may be adopted, or a form in which other features are combined may be adopted.

The process for “specifying the object currently brought into focus” and the process for “specifying the object to which the focus is transferred using the eight-direction operation”, which have been described in the embodiment, are performed in any one of various focus guide outputting methods. It is noted that the signal for informing the user of the object brought into focus is generated even if the content information stored in the optical disk D has no function of displaying the object brought into focus in the plural objects on the screen.

That is, in the standard contents and the advanced contents, the object brought into focus and the object to which the focus is transferred are specified through the above procedure to generate the focus guide. Therefore, the user can easily recognize the object brought into focus and understand in advance the object to which the focus is transferred by the key operation.

<Detailed Description of Focus Guide Process in Reproducing Standard Contents>

The focus guide process performed by the HD DVD reproducing apparatus in reproducing the standard contents will be described in detail with reference to the drawings. FIG. 25 is an explanatory view schematically showing a process for reproducing the standard contents in the HD DVD reproducing apparatus according to an embodiment of the invention.

(Configuration of HD DVD Reproducing Apparatus in Reproducing Standard Contents)

Unlike the advanced contents, the HD DVD reproducing apparatus 10 (standard content portion) does not support the persistent storage (tentative storage memory) and network as the data source with respect to the standard contents, but only reads the standard contents from the optical disk D. The data structure of the standard contents is similar to that of the current DVD.

As shown in FIG. 25, a standard content processing unit of the HD DVD reproducing apparatus 10 deals with general control data (data for whole control such as data structure) supplied from the optical disk D, entry search data (data including data access pointer), user interface control data (data defining a behavior when the user operation is received), navigation control data (the reproduction control data such as title jump), and presentation data (video data and audio data).

As shown in FIG. 25, a standard content processing unit of the HD DVD reproducing apparatus 10 includes the navigation management unit 11, the presentation processing unit 12, and the video and audio processing unit 13. The navigation management unit 11 includes a general control unit 21 which deals with general control data, an entry search unit 22 which deals with entry search data, a user interface control unit 23 which deals with user interface control data, and a navigation control unit 24 which is connected to the operation unit 16 to deal with navigation control data.

The presentation processing unit 12 deals with the presentation data from the optical disk D. As with the advanced contents, because the presentation data is multiplexed, the presentation processing unit 12 performs the decoding process after the demux process. The video and audio processing unit 13 converts the decoded data into the data which can be used in the reproduction, and the data is outputted to the TV monitor or speaker.

The navigation control unit 24 performs the process directly related to the reproduction control, and utilizes the pieces of information from the general control unit 21, the entry search unit 22, the user interface control unit 23, and the presentation processing unit 12 if needed.

(Focus Guide Configuration of HD DVD Reproducing Apparatus in Reproducing Standard Contents)

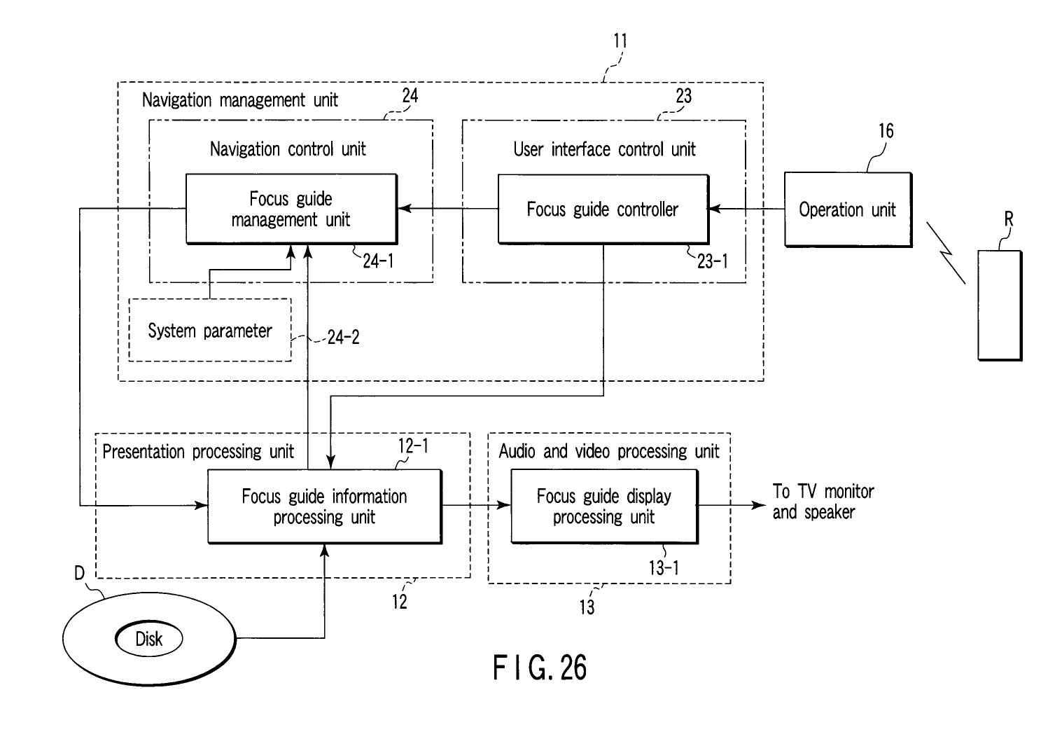

Then, the focus guide configuration of the HD DVD reproducing apparatus 10 in reproducing the standard contents will be described with reference to FIGS. 26 to 31. FIGS. 26 to 31 are block diagrams showing an example of the focus guide process performed to the standard contents in the HD DVD reproducing apparatus according to an embodiment of the invention.

As shown in FIG. 26, the HD DVD reproducing apparatus includes the five new configurations to perform the focus guide process according to an embodiment of the invention.

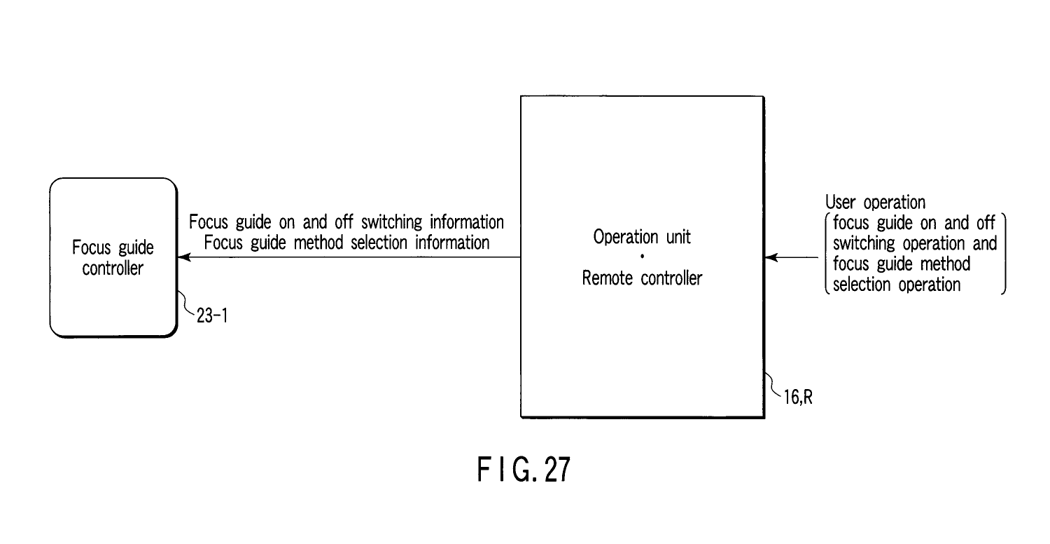

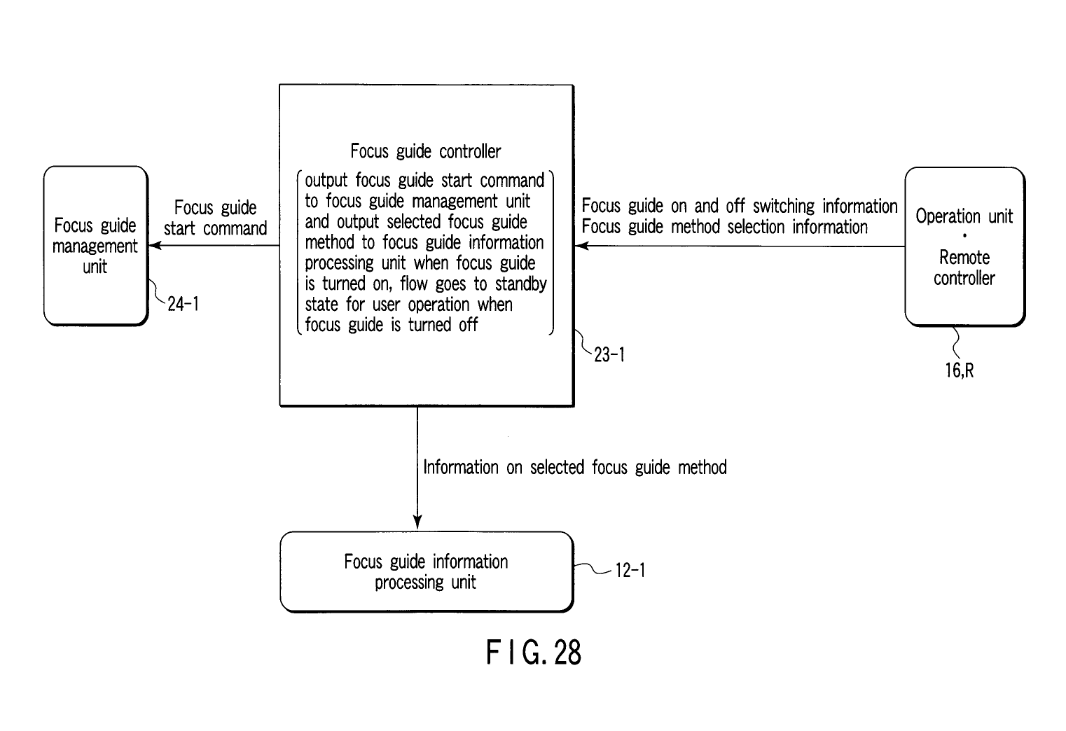

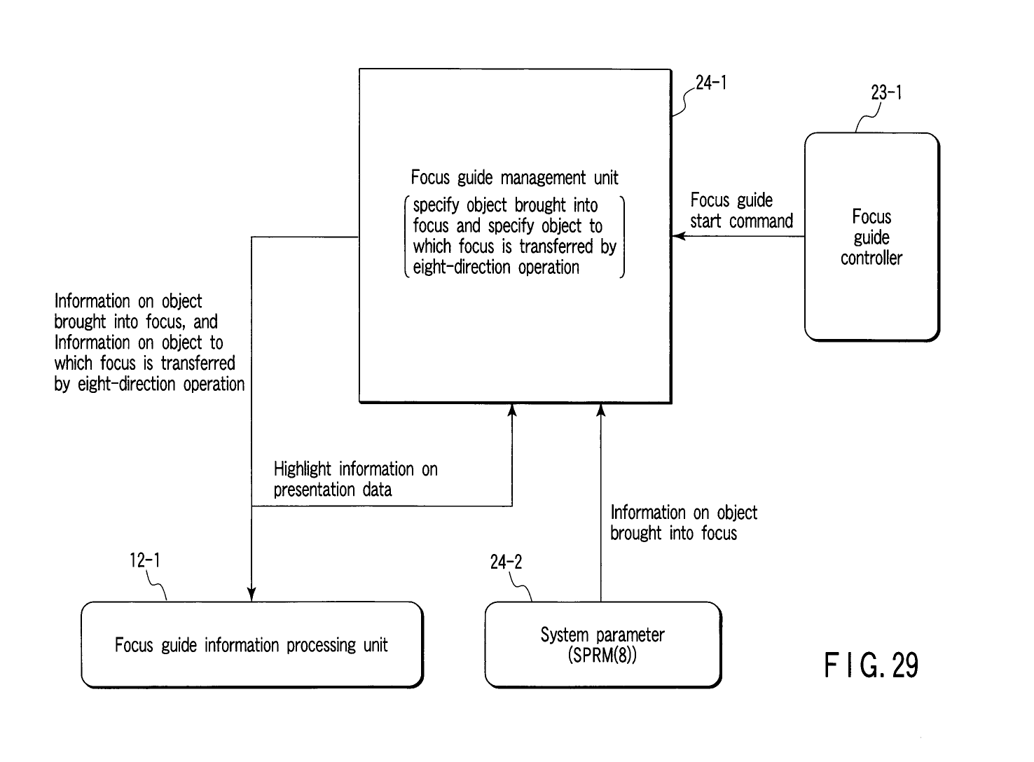

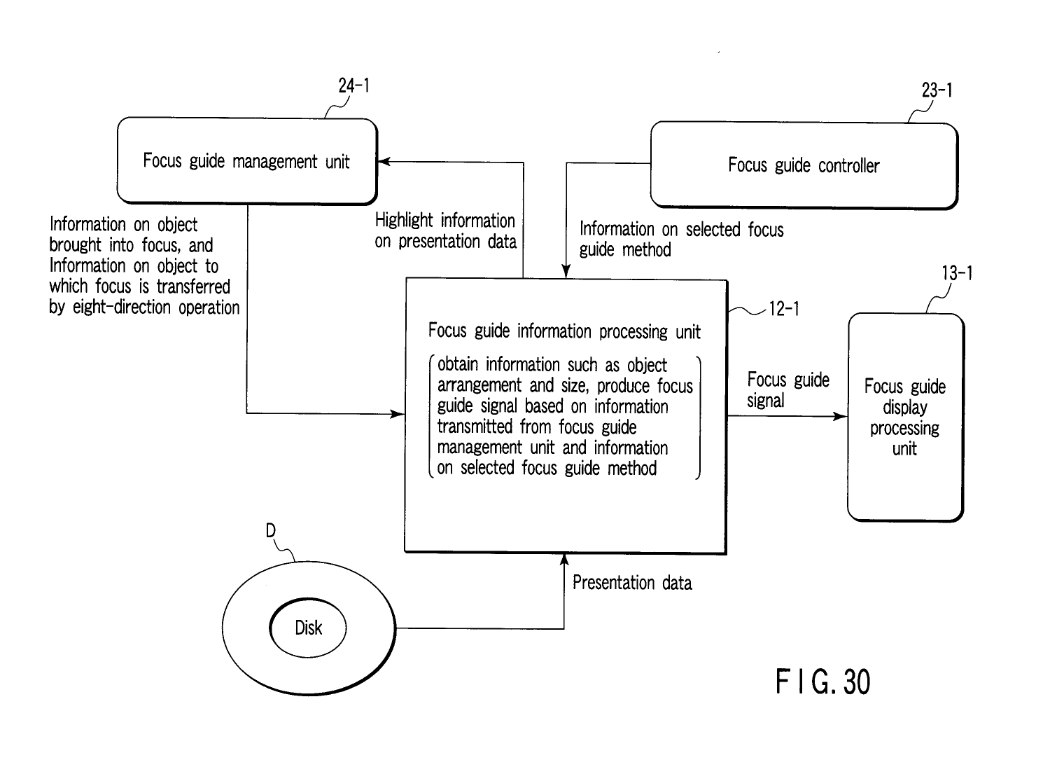

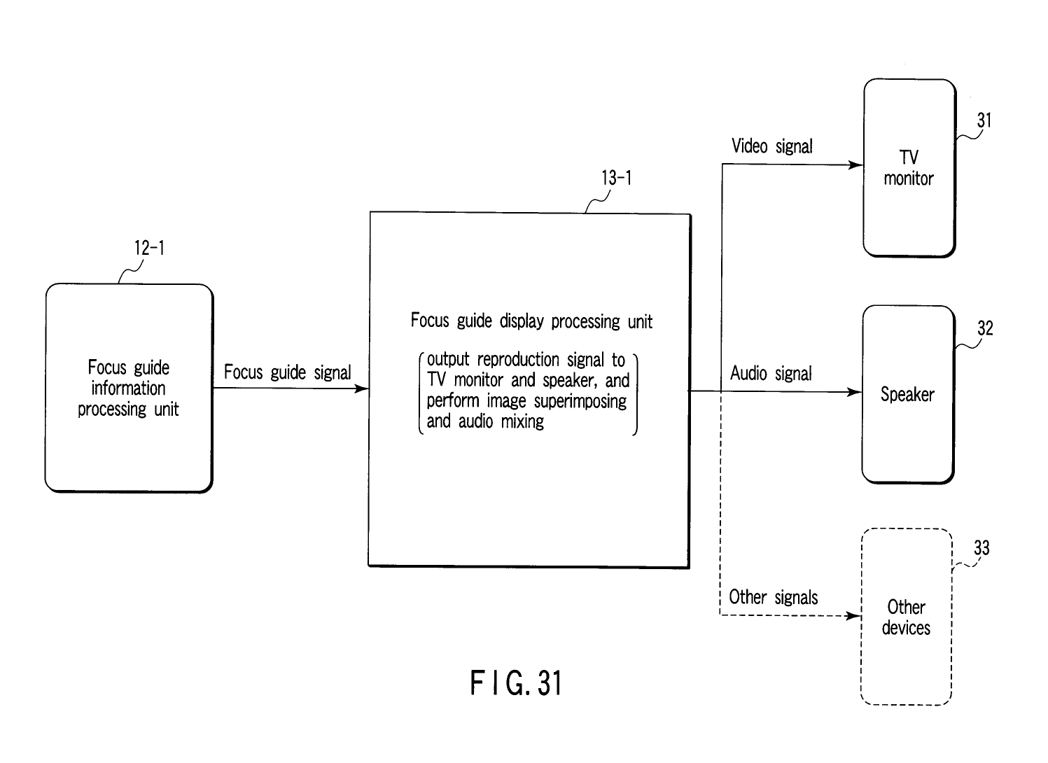

The navigation management unit 11 includes a user interface processing unit 23 and a navigation control unit 24. The user interface processing unit 23 includes a focus guide controller 23-1 having the functions shown in FIGS. 27 and 28, and the navigation control unit 24 includes a focus guide management unit 24-1 and a system parameter 24-2 which have the functions shown in FIG. 29. The presentation processing unit 12 includes the focus guide information processing unit 12-1 having the functions shown in FIG. 30. The video and audio processing unit 13 includes the focus guide display processing unit 13-1 having the functions shown in FIG. 31.

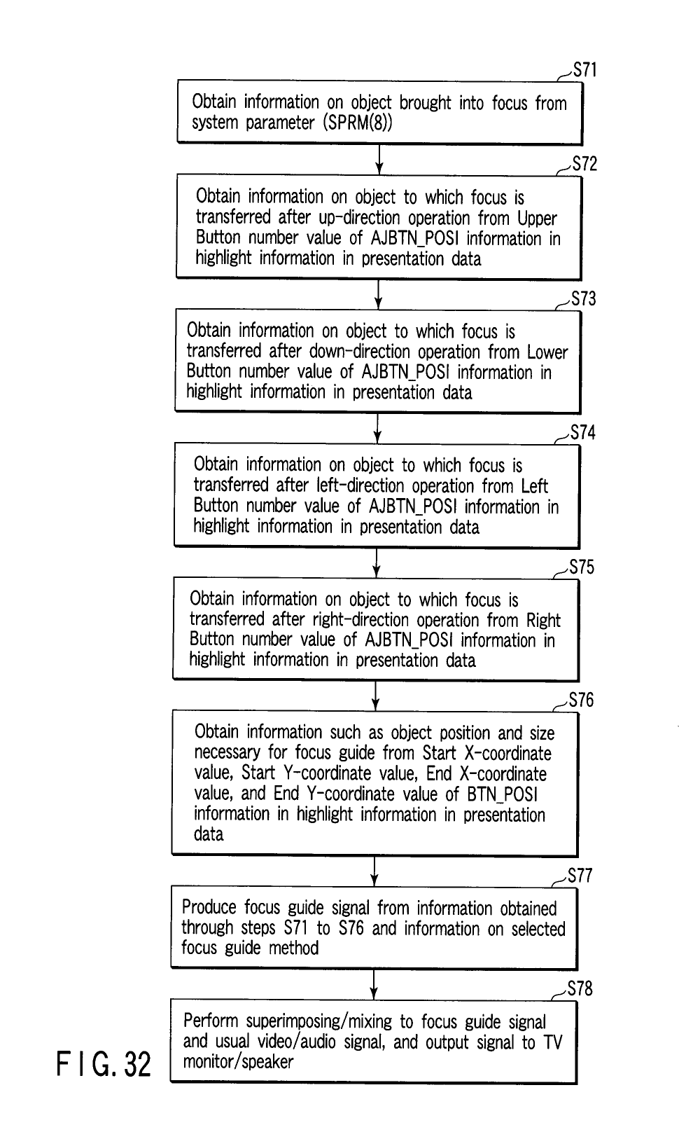

Although the functions of each unit are similar to those of the advanced contents, the standard contents differ from the advanced contents in the method for specifying the object brought into focus, the method for specifying the object to which the focus is transferred, and the information used. The points different from those of the advanced contents will be described in detail later with reference to a flowchart of FIG. 32.

The purposes and functions of the operation unit 16, focus guide controller 23-1, and focus guide display processing unit 13-1 are similar to those of the advanced contents. However, the standard contents differ from the advanced contents in the method for specifying the object brought into focus, the method for specifying the object to which the focus is transferred, and the method for obtaining the information on the detailed focus guide (such as the information on the object position and on the object size). Therefore, the focus guide management unit 24-1 and the focus guide information processing unit 12-1 will be described below with reference to the flowchart of FIG. 32.

(Focus Guide Process Performed by HD DVD Reproducing Apparatus in Reproducing Standard Contents)

Specification of Object Brought into Focus

In the standard contents, a memory called system parameter 24-2 possessed by the HD DVD reproducing apparatus 10 is used in order that the HD DVD reproducing apparatus 10 retains the pieces of information such as a reproduction status and a menu language setting. In the standard contents, the button is the only object brought into focus, and the system parameter SPRM(8) 24-2 manages the information indicating which button is brought into focus and retains the information in HL_BTNN.

Because a unique number is allocated to each button, the focus guide management unit 24-1 can uniquely specify the button brought into focus by referring to the system parameter value (Step S71). The system parameter has the initial value of 1, and the system parameter ranges from 1 to 48. The system parameter value is updated by the focus moving operation of the user, and the system parameter SPRM(8) 24-2 manages the system parameter value.

Specification of Object to which Focus is Transferred

Only the four-direction operation (up, down, right, and left directions) can be permitted in the standard contents. The behavior of the oblique-direction operation depends on the mounted state of the HD DVD reproducing apparatus 10, and no definition is described in the HD DVD standard. Each button retains the information of AJBTN_POSI in the highlight information of the presentation data, and the information of AJBTN_POSI includes a value of Upper Button number (button number of the object to which the focus is transferred when the up-direction operation is performed), a value of Lower Button number (button number of the object to which the focus is transferred when the down-direction operation is performed), a value of Left Button number (button number of the object to which the focus is transferred when the left-direction operation is performed), and a value of Right Button number (button number of the object to which the focus is transferred when the right-direction operation is performed).

The focus guide management unit 24-1 refers sequentially to the values of the up direction, down direction, left direction, and right direction (Steps S72 to S75). This enables the object to which the focus is transferred to be specified. Unlike the advanced contents, the focus transition is not performed by navIndex. In the case where the value is not set to the Upper Button number or the like, a button number of the button itself is allocated, and the focus transition is not performed by the direction operation.

Obtainment of Information Necessary for Focus Guide

In order to specify the position and size of the button brought into focus, the focus guide management unit 24-1 uses information of BTN_POSI on the button included in the highlight information of the presentation data. The information of BTN_POSI includes a value of Start X-coordinate (x coordinate of a start point: upper left end), a value of End X-coordinate (x coordinate of an end point: lower right end), a value of Start Y-coordinate (y coordinate of a start point: upper left end), and a value of End Y-coordinate (y coordinate of an end point: lower right end). Therefore, the X coordinates and the Y coordinates of the start point and end point of the object (button) can be obtained by these values (Step S76).

Production of Focus Guide Signal

Then, the focus guide information processing unit 12-1 generates the focus guide signal based on the pieces of information supplied from the focus guide management unit 24-1 and the information on the focus guide method selected by the user (Step S77).

Although the standard contents differ from the advanced contents in the information obtaining method in Steps S71 to S76, the standard contents are similar to the advanced contents in the focus guide signal producing process based on the information.

Image Superimposing/Audio Mixing

Finally, the focus guide display processing unit 13-1 performs the image superimposing process and the audio mixing process as shown in FIG. 14 based on the focus guide signal supplied from the focus guide information processing unit 12-1 and other usual reproduction signals, and outputs the signal to the TV monitor or speaker like the advanced contents.

As described above, in the focus guide process according to the embodiment of the invention, on the basis of the specification of the object brought into focus and the specification of the object to which the focus is transferred, the object brought into focus can be highlighted, and the object to which the focus is transferred can be displayed by the eight-direction operation such as the arrow display.

Therefore, the focus moving operation of the user can be assisted, and the user can smoothly perform the focus moving operation even if the object arrangement or the focus transition rule is complicated.

Those skilled in the art can make the invention by various above-described embodiments, and it is further understood by those skilled in the art that various changes and modifications can easily be made, and the invention can be applied to various embodiments without inventive ability. Therefore, the present invention covers a wide range consistent with the disclosed principle and the novel characteristic features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk apparatus comprising:
a scanning unit which scans light reflected from an optical disk to output a scan signal;
a management unit which manages which object is currently brought into focus in a plurality of objects on a screen based on the scan signal scanned by the scanning unit and a given operation signal; and
a processing unit which generates a signal for informing a user of the object brought into focus.

2. The optical disk apparatus according to claim 1, wherein the processing unit generates at least one of color information on the object displayed on the screen, character information for specifying the object, moving image information on the object, and audio information for specifying the object, in order to inform the user of the object brought into focus.

3. The optical disk apparatus according to claim 1, wherein the processing unit predicts where the focus is transferred from the object currently brought into focus after one of a plurality of direction keys is pressed, the direction keys being provided in a remote controller supplying the operation signal, and the processing unit generates a signal for informing the user of the object to which the focus is transferred.

4. The optical disk apparatus according to claim 1, wherein the processing unit predicts where the focus is transferred from the object currently brought into focus after direction keys are pressed, the direction keys being provided in a remote controller supplying the operation signal, the direction keys including an up-direction key, a down-direction key, a right-direction key, a left-direction key, an upper right-direction key, a lower right-direction key, an upper left-direction key, and a lower left-direction key to move the object, and the processing unit generates a signal for informing the user of the object to which the focus is transferred.

5. The optical disk apparatus according to claim 1, wherein the management unit determines whether the optical disk scanned by the scanning unit is advanced contents or standard contents, and manages which object is currently brought into focus in said plurality of objects on the screen by different methods according to the determination result, and
the processing unit generates the signal for informing the user of the object brought into focus based on different signals according to the determination result.

6. The optical disk apparatus according to claim 1, wherein, when the optical disk is the advanced contents, the processing unit predicts where the focus is transferred from the object currently brought into focus after one of a plurality of direction keys is pressed, the direction keys being provided in a remote controller supplying the operation signal, and the processing unit generates a signal for informing the user of the object to which the focus is transferred, based on a navUp attribute, a navDown attribute, a navLeft attribute, a navRight attribute, a navLeftUp attribute, a navLeftDown attribute, a navRightUp attribute, and a navRightDown attribute in the scan signal scanned by the scanning unit.

7. The optical disk apparatus according to claim 1, wherein, when the optical disk is the standard contents, the processing unit predicts where the focus is transferred from the object currently brought into focus after one of a plurality of direction keys is pressed, the direction keys being provided in a remote controller supplying the operation signal, and the processing unit generates a signal for informing the user of the object to which the focus is transferred, based an Upper Button number value, a Lower Button number value, a Left Button number value, and a Right Button number value of AJBTN_POSI information in highlight information of presentation data in the scan signal scanned by the scanning unit.

8. An optical disk apparatus comprising:
an optical disk in which content information is stored;
a scanning unit which accommodates the optical disk to irradiate the optical disk with a laser beam, and scans light reflected from the optical disk to read the content information;
a management unit which manages which object is currently brought into focus in a plurality of objects on a screen based on the content information scanned by the scanning unit and a given operation signal; and
a processing unit which generates a signal for informing a user of the object brought into focus even if the content information has no function of displaying which object is brought into focus in said plurality of objects on the screen.

9. An optical disk processing method comprising:
reading content information from an optical disk in which the content information is stored;
managing which object is currently brought into focus in a plurality of objects on a screen based on the content information and a given operation signal;
generating a signal for informing a user of the object brought into focus even if the content information has no function of displaying which object is brought into focus in said plurality of objects on the screen.

10. The optical disk processing method according to claim 9, further comprising generating at least one of color information on the object displayed on the screen, character information for specifying the object, moving image information on the object, and audio information for specifying the object, in order to inform the user of the object brought into focus.
